(19) United States
(12) Patent Application Publication
(10) Pub. No.: US 2025/0384367 A1
(43) Pub. Date: Dec. 18, 2025

(54) SYSTEM AND METHOD FOR OPTIMIZING LOGISTICS OPERATIONS THROUGH INTEGRATED NETWORK TECHNOLOGIES

(71) Applicant: OTIF Corporation, Austin, TX (US)

(72) Inventors: Pamela Villarreal Gonzalez, Nuevo Leon (MX); Hector Antonio Cardenas Marcos, Brooklyn, NY (US)

(73) Assignee: OTIF Corporation, Austin, TX (US)

(21) Appl. No.: 19/239,624

(22) Filed: Jun. 16, 2025

Related U.S. Application Data
(60) Provisional application No. 63/660,425, filed on Jun. 14, 2024.

(51) Int. Cl. G06Q 10/0631; G06Q 10/087; G06Q 30/0202

(52) U.S. Cl. CPC G06Q 10/06313; G06Q 10/087; G06Q 30/0202

(57) ABSTRACT

The disclosed system and method integrate multiple supply chain ecosystems into a cohesive network using a centralized operator. The system interconnects physical and mobile infrastructures, networks, and smart sensors. An Artificial Intelligence of Things (AIOT) module provides real-time visibility into dynamic pricing, booking availability, payment processing, smart contract execution, and traceability of physical and online goods. A high-performance computing module, comprising Central Processing Units (CPUs) and Graphics Processing Units (GPUs), executes complex algorithms and deep learning models for rapid data processing and analytics. The system empowers logistics operators with actionable insights and precise control over supply chain operations.

### CROSS-REFERENCE TO RELATED APPLICATION

This application claims priority to and the benefit of U.S. Patent Application No. 63/660,425, titled SYSTEM AND METHOD FOR OPTIMIZING LOGISTICS OPERATIONS THROUGH INTEGRATED NETWORK TECHNOLOGIES, filed Jun. 14, 2024, which is hereby incorporated by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the present disclosure, and the applicants make no claim to any trademarks referenced.

### BACKGROUND OF THE DISCLOSURE

### 1. Field of the Disclosure

The present disclosure relates to supply chain management systems, and more particularly to an integrated logistics network system and method leveraging Artificial Intelligence of Things (AIoT) for optimizing global supply chain operations.

### 2. Description of Related Art

Currently the state of the art includes supply chain management and logistics networks.

In the realm of supply chain management, logistics operations play a central role in ensuring the efficient movement of goods from suppliers to end customers. These operations encompass a wide range of activities, including transportation, warehousing, inventory management, order fulfillment, and customer service. The complexity of these operations increases exponentially when dealing with global supply chains, which involve multiple stakeholders, diverse modes of transportation, and cross-border regulations.

A supply chain ecosystem refers to the interconnected network of suppliers, manufacturers, distributors, retailers, and customers involved in the production and distribution of goods. These ecosystems are often disparate and disjointed, with each stakeholder operating independently and using different systems for data management and communication. This lack of integration may lead to inefficiencies, delays, and increased costs in supply chain operations.

Artificial Intelligence of Things (AIoT) is a technological paradigm that combines the connectivity and data gathering capabilities of the Internet of Things (IoT) with the data processing and decision-making capabilities of Artificial Intelligence (AI). IoT refers to the network of physical devices, vehicles, appliances, and other items embedded with sensors, software, and network connectivity that enable these objects to collect and exchange data. AI, on the other hand, refers to the simulation of human intelligence processes by machines, especially computer systems. These processes include learning, reasoning, problem-solving, perception, and language understanding.

Central Processing Units (CPUs) and Graphics Processing Units (GPUs) are integral components of modern computing systems. CPUs are the primary component of a computer that performs the majority of processing inside the computer. They handle the basic system instructions, such as processing mouse and keyboard input and running applications. GPUs, on the other hand, are specialized electronic circuits designed to rapidly manipulate and alter memory to accelerate the creation of images in a frame buffer intended for output to a display device. GPUs are used in embedded systems, mobile phones, personal computers, workstations, and game consoles.

In the context of supply chain management, high-performance computing capabilities, including CPUs and GPUs, may be leveraged to execute complex algorithms and deep learning models efficiently. This enables rapid data processing and analytics, which are integral for real-time visibility into dynamic pricing, booking availability, and secure reservations across interconnected supply chains.

When the related art is viewed in the context of supply chain management and logistics networks has traditionally involved a variety of disparate systems and methods for tracking, managing, and coordinating the movement of goods. These systems have often operated in silos, with limited interoperability and data sharing capabilities. Communication among participants in the supply chain—such as suppliers, customers, distributors, and transporters—has typically relied on conventional mediums like voice calls, email, and text messaging over mobile networks.

Prior art logistics systems have utilized various forms of technology to manage operations, including Electronic Data Interchange (EDI), Transportation Management Systems (TMS), Warehouse Management Systems (WMS), and Global Positioning Systems (GPS). While these technologies have provided some level of automation and visibility, they have not been fully integrated, resulting in inefficiencies and a lack of real-time data analytics.

In the realm of the Internet of Things (IoT), related art has seen the deployment of smart sensors and devices to monitor and track assets. However, these IoT solutions have often lacked advanced analytics and artificial intelligence capabilities, limiting their ability to optimize logistics processes.

Artificial Intelligence (AI) has been applied in some logistics and supply chain systems to improve forecasting and decision-making. However, the integration of AI with IoT—known as the Artificial Intelligence of Things (AIoT)—is a relatively recent development that has not been widely adopted in the related art. AIoT promises to enhance the intelligence of IoT devices by enabling them to analyze data and make autonomous decisions, but its application in supply chain management is still emerging.

Furthermore, the related art has not fully addressed the challenges of integrating multiple supply chains into a cohesive network. The lack of a unified platform that may synchronize and optimize operations across various modes of transportation and logistics services has been a persistent issue.

In summary, while the related art has made strides in applying technology to logistics and supply chain management, there remains a gap in creating a fully integrated, intelligent, and responsive logistics network that leverages the full potential of AIoT to streamline operations, reduce costs, and improve transparency across global supply chains. The instant technology seeks to address these gaps by providing a comprehensive system and method for integrating multiple supply chain ecosystems into a single, intelligent network.

These and other objects, features, and advantages of the present disclosure will become more readily apparent from the attached drawings and the detailed description of the preferred embodiments, which follow.

### SUMMARY OF THE DISCLOSURE

The instant technology, Systems and Methods for a Logistics Network (instant disclosure), is a comprehensive system and method designed to integrate multiple supply chain ecosystems into a cohesive, intelligent network powered by Artificial Intelligence of Things (AIoT). It aims to optimize global supply chain operations by consolidating, orchestrating, and streamlining logistics processes to provide real-time visibility into dynamic pricing, booking availability, payment processing, smart contract execution, and traceability of goods.

The technology interconnects advanced physical and mobile infrastructures, networks, and smart sensors, acting as a centralized operator that enhances efficiency, responsiveness, and transparency across supply chain networks. It leverages AIoT to reduce costs, accelerate trade, and foster innovation worldwide.

The system addresses the challenge of integrating disparate supply chains by connecting clients and suppliers through advanced transportation infrastructures and smart devices, using principles of IoT and AIoT. It enhances supply chain efficiency by reducing computational and memory access requirements during model operation and integrates intelligence engines, workflow automation, and real-time data analytics.

The instant disclosure functions by interconnecting and synchronizing across multiple networks to create a unified infrastructure. It employs components such as Intelligence Engines, Advanced Integration Engines, Workflow Automatization, a Mobility Suite, Communications Engines, and Partner Applications to facilitate robust connectivity and seamless information exchange.

The instant disclosure also integrates physical devices like cell phones, GPS, and IoT sensors to capture real-time data on asset parameters, empowering logistics operators with actionable insights and precise control over supply chain operations. The technology is illustrated through a series of figures that depict the system and method, including the various layers and components that make up the instant disclosure.

According to an aspect of the present disclosure, a logistics network system includes a centralized operator configured to integrate multiple supply chain ecosystems into a cohesive network. The system includes a set of interconnected physical and mobile infrastructures, networks, and smart sensors. The system also includes an Artificial Intelligence of Things (AIoT) module configured to provide real-time visibility into dynamic pricing, booking availability, payment processing, smart contract execution, and traceability of physical and online goods. The system further includes a high-performance computing module comprising Central Processing Units (CPUs) and Graphics Processing Units (GPUs) configured to execute complex algorithms and deep learning models for rapid data processing and analytics.

According to other aspects of the present disclosure, the logistics network system may include a centralized operator configured to synchronize the multiple supply chain ecosystems to facilitate seamless communication and information flow. The synchronization may include large-scale transmission capabilities to connect clients and suppliers through the interconnected physical and mobile infrastructures, networks, and smart sensors. The AIoT module may be further configured to enhance efficiency, responsiveness, and transparency across the supply chain networks. The high-performance computing module may be further configured to execute complex algorithms and deep learning models for rapid data processing and analytics, enabling dynamic pricing, booking availability, and secure reservations across interconnected supply chains. The set of interconnected physical and mobile infrastructures, networks, and smart sensors may include devices for capturing real-time data on asset parameters such as geolocation, temperature, humidity, vibrations, shock, and light. The real-time data may be used to empower logistics operators with actionable insights and precise control over supply chain operations.

According to another aspect of the present disclosure, a method for optimizing global supply chain operations includes the steps of integrating multiple supply chain ecosystems into a cohesive network using a centralized operator, interconnecting physical and mobile infrastructures, networks, and smart sensors, leveraging Artificial Intelligence of Things (AIoT) technologies to provide real-time visibility into dynamic pricing, booking availability, payment processing, smart contract execution, and traceability of physical and online goods, and utilizing high-performance computing capabilities, including Central Processing Units (CPUs) and Graphics Processing Units (GPUs), to execute complex algorithms and deep learning models for rapid data processing and analytics.

According to other aspects of the present disclosure, the method may include a centralized operator further comprising a data processing module configured to analyze and interpret data from the interconnected physical and mobile infrastructures, networks, and smart sensors. The data processing module may be further configured to generate predictive analytics based on the analyzed and interpreted data. The AIoT module may further comprise a machine learning algorithm configured to adapt and optimize the real-time visibility based on historical data and trends. The high-performance computing capabilities may further comprise a parallel processing module configured to simultaneously execute multiple complex algorithms and deep learning models. The method may further comprise a step of tokenizing the real-time visibility data to secure and anonymize sensitive information. The integrating step may further comprise a step of synchronizing the multiple supply chain ecosystems based on predefined criteria.

In summary, the instant technology represents a transformative approach to supply chain management, leveraging the convergence of AI, IoT, and AIoT to create an intelligent, efficient, and interconnected logistics network that redefines global trade and commerce in the digital age.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram, in accordance with some embodiments of the present disclosure, an exemplary system and method of the instant disclosure Logistics Network;

FIG. 2 illustrates, in accordance with some embodiments of the present disclosure, a system and method of data transfer and tokenization for the logistics movements made through a Logistics Third Party better known as Freight Forwarder and/or 4PL;

FIG. 3A illustrates, in accordance the present disclosure, an agreement transaction layer including a payment system and smart contracts system;

FIG. 3B illustrates, in accordance the present disclosure, an agreement for smart contracts system;

FIGS. 4A, 4B and 4C illustrates, in accordance with some embodiments of the present disclosure, a transportation carriers' layer that consists of road, air, and sea cargo companies;

FIGS. 5A, 5B and 5C illustrates, in accordance with some embodiments of the present disclosure, a physical infrastructure layer that shows in detail the data on ports, customs, and warehouse companies;

FIGS. 6A, 6B, 6C and 6D illustrates, in accordance with some embodiments of the present disclosure, an example of Shippers in the supply chain. Consisting mainly of End customers, Retail Companies, Trading Companies, and Manufacturers;

FIGS. 7A, 7B and 7C illustrates, in accordance with some embodiments of the present disclosure, an exemplary process for the instant disclosure Logistics Management Device for Mobile devices and GPS relying on 5G and IoT devices going through the LoRaWAN Network for the tracking of assets and a set of data;

FIG. 8 illustrates through a diagram, in accordance with some embodiments of the present disclosure, an exemplary system and method of the instant disclosure Logistics Server Layer; and

FIG. 9 illustrates the Multiple Telemetry Device leverages various technologies to enhance the intelligence and security of the instant disclosure.

Corresponding reference characters indicate corresponding parts throughout the several views. The exemplifications set out herein illustrate embodiments of the disclosure and such exemplifications are not to be construed as limiting the scope of the disclosure in any manner.

### DETAILED DESCRIPTION

While various aspects and features of certain embodiments have been summarized above, the following detailed description illustrates a few exemplary embodiments in further detail to enable one skilled in the art to practice such embodiments. The examples described are provided for illustrative purposes and are not intended to limit the scope of the disclosure.

In the following description, for the purposes of explanation, numerous specific details are set forth in order to provide a thorough understanding of the described embodiments. It will be apparent to one skilled in the art however that other embodiments of the present disclosure may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the disclosure, as other embodiments of the disclosure may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this disclosure is susceptible to embodiments of many different forms, it is intended that the present disclosure be considered as an example of the principles of the disclosure and not intended to limit the disclosure to the specific embodiments shown and described.

The convergence of Artificial Intelligence (AI), Internet of Things (IoT), and specifically, Artificial Intelligence of Things (AIoT), through the instant technology, heralds a new era of supply chain optimization. AI technologies empower supply chain managers to process vast datasets, derive actionable insights, and transform global supply chain operations. With AI embedded in the instant technology, managers gain visibility into pricing, real-time asset tracking, and predictive capabilities for proactive decision-making across road, air, and sea freight operations.

IoT complements AI within the instant technology by providing a network of interconnected devices and sensors that generate real-time data about assets, shipments, and environmental conditions. This data fuels AI-driven analytics, enabling precise monitoring, tracking, and control over supply chain activities. The integration of AI with IoT (AIoT) empowers the instant technology to analyze complex supply chain data, enhance adaptability, and automate critical processes like payments, credit applications, and smart contracts through geofencing and Service Level Agreement fulfillment.

By harnessing AIoT technologies, the instant technology (the instant technology) streamlines logistics operations, enhances global supply chain visibility, and drives economic growth and resilience in trade networks. This convergence of AI, IoT, and AIoT within the instant technology signifies a paradigm shift towards intelligent, efficient, and interconnected supply chain networks that redefine global trade and commerce in the digital age.

The instant technology Logistics Network operating system functions by interconnecting and synchronizing across multiple networks to create a unified, large-scale transmission infrastructure. This system integrates and connects diverse supply chains into a smart network operator, effectively bridging advanced transportation infrastructures, interconnected networks, and smart devices with end customers. The instant technology leverages components such as Intelligence Engines, Advanced Integration Engines, Workflow Automatization, a Mobility Suite, Communications Engines, and Partner Applications to facilitate robust connectivity and seamless information exchange among clients and suppliers within the supply chain.

Furthermore, the instant technology integrates physical devices like cell phones, GPS, and IoT sensors to capture real-time data on asset parameters such as geolocation, temperature, humidity, vibrations, shock, and light. This comprehensive integration empowers logistics operators with actionable insights and precise control over supply chain operations, facilitating proactive decision-making and seamless coordination across global logistics networks.

As one may readily see, the present disclosure relates to a system and method for optimizing global supply chain operations. In particular, the present disclosure may provide a comprehensive logistics network system, referred to as the instant disclosure Logistics Network (instant disclosure), designed to integrate disparate supply chain ecosystems into a cohesive, intelligent network. This network is powered by the Artificial Intelligence of Things (AIoT), which enhances efficiency, responsiveness, and transparency across supply chain networks. The instant disclosure leverages advanced physical and mobile infrastructures, interconnected networks, and smart sensors to optimize global supply chain operations.

More specifically, the instant disclosure acts as a centralized operator that consolidates, orchestrates, and streamlines logistics processes. This operator provides real-time visibility into dynamic pricing, booking availability, payment processing, smart contract execution, and traceability of physical and online goods. The instant disclosure also leverages high-performance computing capabilities, including Central Processing Units (CPUs) and Graphics Processing Units (GPUs), to execute complex algorithms and deep learning models efficiently. This enables rapid data processing and analytics, which are integral to achieving dynamic pricing, booking availability, and secure reservations across interconnected supply chains.

In some aspects, the instant disclosure may integrate and synchronize multiple networks into a superstructure capable of large-scale transmission. This integration facilitates seamless communication and information flow, connecting clients and suppliers through advanced transportation infrastructures, smart sensors, and devices. The instant disclosure may also utilize IoT devices to capture real-time data on asset parameters such as geolocation, temperature, humidity, vibrations, shock, and light. This comprehensive integration empowers logistics operators with actionable insights and precise control over supply chain operations, facilitating proactive decision-making and seamless coordination across global logistics networks.

In other aspects, the instant disclosure may leverage AIoT technologies to enhance efficiency, responsiveness, and transparency across supply chain networks. By harnessing the power of AIoT, the instant disclosure may provide real-time visibility into dynamic pricing, booking availability, payment processing, smart contract execution, and traceability of physical and online goods. This real-time visibility and dynamic data processing capability may revolutionize supply chain management, overcoming the limitations and inefficiencies of existing alternatives.

The instant disclosure also offers a comprehensive, intelligent, and efficient solution for global supply chain management. By integrating disparate supply chain ecosystems into a cohesive, intelligent network, the instant disclosure may enhance collaboration, transparency, and efficiency across the supply chain. This innovative approach ensures efficient, interconnected, and transparent logistics management in the era of intelligent supply chains.

In some aspects, the logistics network system may include a centralized operator. This operator may be configured to integrate multiple supply chain ecosystems into a cohesive network. The integration of these disparate supply chain ecosystems may facilitate seamless communication and information flow, enhancing collaboration and transparency across the supply chain. The centralized operator may act as a hub, connecting various stakeholders within the supply chain and enabling efficient coordination of logistics processes.

In some cases, the centralized operator may not just integrate the supply chain ecosystems but may also actively orchestrate and streamline logistics processes. This could involve coordinating the movement of goods, managing inventory, and overseeing payment processing and contract execution. By consolidating these diverse operations under a single operator, the logistics network system may enhance operational efficiency and reduce complexities associated with managing multiple, disjointed supply chain ecosystems.

In other aspects, the centralized operator may be configured to consolidate, orchestrate, and streamline logistics processes, instead of integrating multiple supply chain ecosystems into a cohesive network. This variation may be particularly beneficial in scenarios where the supply chain ecosystems are already interconnected but require further optimization and coordination. The centralized operator in this configuration may act as a control center, managing and optimizing logistics processes across the interconnected supply chain ecosystems. This may lead to improved operational efficiency, reduced redundancies, and enhanced responsiveness to changes in supply and demand.

In some aspects, the logistics network system may include a set of interconnected physical and mobile infrastructures, networks, and smart sensors. These components may collectively form a robust and versatile framework that supports the operations of the logistics network system. The physical and mobile infrastructures may include various types of hardware and devices, such as servers, routers, switches, and mobile devices, which facilitate data transmission and communication within the network. The networks may include both wired and wireless networks, enabling seamless connectivity across diverse geographical locations and operational environments. The smart sensors may be IoT devices that capture real-time data on various parameters, such as location, temperature, humidity, vibrations, shock, and light. This data may provide valuable insights into the status and conditions of goods in transit, enabling proactive decision-making and efficient resource allocation.

In some cases, the set of interconnected physical and mobile infrastructures, networks, and smart sensors may include devices for capturing real-time data on asset parameters such as geolocation, temperature, humidity, vibrations, shock, and light. These devices may be strategically placed on or within goods, containers, vehicles, or other assets involved in the supply chain. The real-time data captured by these devices may provide a wealth of information about the status and conditions of the assets, enabling logistics operators to monitor and manage the assets effectively. For instance, geolocation data may provide real-time tracking of assets, temperature and humidity data may indicate the environmental conditions of the assets, and vibration and shock data may reveal any potential damage or mishandling of the assets. This comprehensive visibility into asset parameters may enhance operational efficiency, reduce risks, and improve customer satisfaction.

In other aspects, the physical and mobile infrastructures, networks, and smart sensors may be interconnected in a manner that facilitates seamless communication and data flow within the logistics network system. This interconnection may be achieved through various networking technologies and protocols, such as Ethernet, Wi-Fi, 5G, and LoRaWAN®, among others. The interconnected infrastructures, networks, and sensors may collectively form a robust and resilient network that supports the efficient transmission and processing of data. This may enhance the responsiveness and adaptability of the logistics network system, enabling it to effectively handle dynamic changes in supply and demand, fluctuating market conditions, and other operational challenges.

In some aspects, the logistics network system may include an Artificial Intelligence of Things (AIoT) module. This module may be configured to provide real-time visibility into dynamic pricing, booking availability, payment processing, smart contract execution, and traceability of physical and online goods. The AIoT module may leverage advanced AI algorithms and IoT technologies to process and analyze data from various sources within the supply chain. This may enable the module to generate real-time insights into various aspects of the supply chain, such as pricing trends, booking availability, payment status, contract execution, and the location and status of goods. By providing this real-time visibility, the AIoT module may enhance decision-making, improve operational efficiency, and increase transparency across the supply chain.

In some cases, the AIoT module may leverage Artificial Intelligence of Things (AIoT) technologies to provide real-time visibility into dynamic pricing, booking availability, payment processing, smart contract execution, and traceability of physical and online goods. These AIoT technologies may include machine learning algorithms, neural networks, and other AI techniques, as well as IoT devices and sensors. The AIoT technologies may enable the module to process and analyze large volumes of data in real-time, facilitating rapid and accurate insights into various aspects of the supply chain. This may enhance the responsiveness and adaptability of the logistics network system, enabling it to effectively respond to changes in market conditions, customer demands, and other operational factors.

In other aspects, the AIoT module may further comprise a machine learning algorithm configured to adapt and optimize the real-time visibility based on historical data and trends. The machine learning algorithm may analyze past data and trends within the supply chain to predict future patterns and behaviors. This predictive capability may enable the AIoT module to anticipate changes in pricing, booking availability, payment processing, and other aspects of the supply chain, allowing logistics operators to make proactive decisions and adjustments. By leveraging machine learning algorithms, the AIoT module may continuously learn and adapt to changing conditions, enhancing the efficiency and effectiveness of the logistics network system.

In some aspects, the logistics network system may include a high-performance computing module. This module may be configured to execute complex algorithms and deep learning models for rapid data processing and analytics. The high-performance computing module may comprise Central Processing Units (CPUs) and Graphics Processing Units (GPUs). CPUs, often referred to as the “brain” of a computer, are utilized for general-purpose computations, managing logistics operations, and processing real-time data streams. GPUs, on the other hand, are designed to accelerate intensive parallel processing tasks such as image recognition and optimization algorithms within AIoT applications. By harnessing the computational power of CPUs and GPUs, the high-performance computing module may achieve rapid data processing and analytics.

In some cases, the high-performance computing module may execute complex algorithms and deep learning models for rapid data processing and analytics, enabling dynamic pricing, booking availability, and secure reservations across interconnected supply chains. This functionality may be particularly beneficial in scenarios where real-time decision-making is paramount. For instance, dynamic pricing algorithms may adjust prices in real-time based on supply and demand fluctuations, booking availability algorithms may optimize resource allocation based on current bookings and capacity constraints, and secure reservation algorithms may ensure secure and efficient reservation processes. By enabling these functionalities, the high-performance computing module may enhance the responsiveness and adaptability of the logistics network system, leading to improved operational efficiency and customer satisfaction.

In other aspects, the logistics network system may utilize high-performance computing capabilities, including Central Processing Units (CPUs) and Graphics Processing Units (GPUs), to execute complex algorithms and deep learning models for rapid data processing and analytics. This operational variation may leverage the inherent computational power of CPUs and GPUs to handle the intensive computational demands of complex algorithms and deep learning models. By integrating these advanced computing capabilities into the logistics network system, the system may efficiently process large volumes of data, execute complex computations, and deliver real-time analytics. This may enhance the system's ability to make informed decisions, optimize logistics operations, and respond effectively to dynamic changes in the supply chain environment.

In some aspects, the centralized operator of the logistics network system may synchronize the multiple supply chain ecosystems to facilitate seamless communication and information flow. This synchronization may involve aligning the operations of the different supply chain ecosystems to ensure that they work in harmony towards common objectives. For instance, the centralized operator may coordinate the movement of goods, manage inventory levels, and oversee payment processing and contract execution across the interconnected supply chains. By synchronizing these diverse operations, the centralized operator may enhance the overall efficiency and effectiveness of the logistics network system.

In some cases, the centralized operator may further comprise a data processing module configured to analyze and interpret data from the interconnected physical and mobile infrastructures, networks, and smart sensors. This data processing module may utilize advanced algorithms and computational techniques to process and analyze the vast amounts of data generated by the various components of the logistics network system. The data processing module may interpret this data to derive actionable insights, such as trends in demand, fluctuations in pricing, and patterns in logistics operations. These insights may inform decision-making processes, enabling logistics operators to optimize operations, improve efficiency, and enhance customer satisfaction.

In other aspects, the centralized operator may not just synchronize the supply chain ecosystems but may also actively orchestrate and streamline logistics processes. This could involve coordinating the movement of goods, managing inventory, and overseeing payment processing and contract execution. By consolidating these diverse operations under a single operator, the logistics network system may enhance operational efficiency and reduce complexities associated with managing multiple, disjointed supply chain ecosystems. The centralized operator in this configuration may act as a control center, managing and optimizing logistics processes across the interconnected supply chain ecosystems. This may lead to improved operational efficiency, reduced redundancies, and enhanced responsiveness to changes in supply and demand.

In some aspects, the logistics network system may include large-scale transmission capabilities that connect clients and suppliers through the interconnected physical and mobile infrastructures, networks, and smart sensors. This synchronization may be facilitated by the centralized operator, which integrates and synchronizes multiple supply chain ecosystems into a superstructure capable of large-scale transmission. This large-scale transmission capability may enable seamless communication and information flow between clients and suppliers, enhancing collaboration and transparency across the supply chain. For instance, advanced transportation infrastructures, smart sensors, and devices may be interconnected to facilitate the transmission of data and information across vast geographical distances and diverse operational environments. This may enhance the responsiveness and adaptability of the logistics network system, enabling it to effectively respond to changes in market conditions, customer demands, and other operational factors.

In some cases, the synchronization may include large-scale transmission capabilities to connect clients and suppliers through the interconnected physical and mobile infrastructures, networks, and smart sensors. This variation may be particularly beneficial in scenarios where the supply chain ecosystems are already interconnected but require further optimization and coordination. The large-scale transmission capabilities may facilitate the exchange of data and information across the interconnected supply chain ecosystems, enhancing the overall efficiency and effectiveness of the logistics network system. By enabling seamless communication and information flow, the logistics network system may enhance operational efficiency, reduce redundancies, and enhance responsiveness to changes in supply and demand.

In some aspects, the logistics network system may include an Artificial Intelligence of Things (AIoT) module. This module may be configured to enhance efficiency, responsiveness, and transparency across supply chain networks. The AIoT module may leverage advanced AI algorithms and IoT technologies to process and analyze data from various sources within the supply chain. This may enable the module to generate real-time insights into various aspects of the supply chain, such as pricing trends, booking availability, payment status, contract execution, and the location and status of goods. By providing this real-time visibility, the AIoT module may enhance decision-making, improve operational efficiency, and increase transparency across the supply chain.

In some cases, the AIoT module may leverage Artificial Intelligence of Things (AIoT) technologies to provide real-time visibility into dynamic pricing, booking availability, payment processing, smart contract execution, and traceability of physical and online goods. These AIoT technologies may include machine learning algorithms, neural networks, and other AI techniques, as well as IoT devices and sensors. The AIoT technologies may enable the module to process and analyze large volumes of data in real-time, facilitating rapid and accurate insights into various aspects of the supply chain. This may enhance the responsiveness and adaptability of the logistics network system, enabling it to effectively respond to changes in market conditions, customer demands, and other operational factors.

In other aspects, the AIoT module may further comprise a machine learning algorithm configured to adapt and optimize the real-time visibility based on historical data and trends. The machine learning algorithm may analyze past data and trends within the supply chain to predict future patterns and behaviors. This predictive capability may enable the AIoT module to anticipate changes in pricing, booking availability, payment processing, and other aspects of the supply chain, allowing logistics operators to make proactive decisions and adjustments. By leveraging machine learning algorithms, the AIoT module may continuously learn and adapt to changing conditions, enhancing the efficiency and effectiveness of the logistics network system.

In some aspects, the logistics network system may include a high-performance computing module. This module may be configured to execute complex algorithms and deep learning models for rapid data processing and analytics. The high-performance computing module may comprise Central Processing Units (CPUs) and Graphics Processing Units (GPUs). CPUs, often referred to as the “brain” of a computer, are utilized for general-purpose computations, managing logistics operations, and processing real-time data streams. GPUs, on the other hand, are designed to accelerate intensive parallel processing tasks such as image recognition and optimization algorithms within AIoT applications. By harnessing the computational power of CPUs and GPUs, the high-performance computing module may achieve rapid data processing and analytics.

In some cases, the high-performance computing module may execute complex algorithms and deep learning models for rapid data processing and analytics, enabling dynamic pricing, booking availability, and secure reservations across interconnected supply chains. This functionality may be particularly beneficial in scenarios where real-time decision-making is paramount. For instance, dynamic pricing algorithms may adjust prices in real-time based on supply and demand fluctuations, booking availability algorithms may optimize resource allocation based on current bookings and capacity constraints, and secure reservation algorithms may ensure secure and efficient reservation processes. By enabling these functionalities, the high-performance computing module may enhance the responsiveness and adaptability of the logistics network system, leading to improved operational efficiency and customer satisfaction.

In other aspects, the logistics network system may utilize high-performance computing capabilities, including Central Processing Units (CPUs) and Graphics Processing Units (GPUs), to execute complex algorithms and deep learning models for rapid data processing and analytics. This operational variation may leverage the inherent computational power of CPUs and GPUs to handle the intensive computational demands of complex algorithms and deep learning models. By integrating these advanced computing capabilities into the logistics network system, the system may efficiently process large volumes of data, execute complex computations, and deliver real-time analytics. This may enhance the system's ability to make informed decisions, optimize logistics operations, and respond effectively to dynamic changes in the supply chain environment.

In some aspects, the logistics network system may include a set of interconnected physical and mobile infrastructures, networks, and smart sensors. These components may collectively form a robust and versatile framework that supports the operations of the logistics network system. The physical and mobile infrastructures may include various types of hardware and devices, such as servers, routers, switches, and mobile devices, which facilitate data transmission and communication within the network. The networks may include both wired and wireless networks, enabling seamless connectivity across diverse geographical locations and operational environments. The smart sensors may be IoT devices that capture real-time data on various parameters, such as location, temperature, humidity, vibrations, shock, and light. This data may provide valuable insights into the status and conditions of goods in transit, enabling proactive decision-making and efficient resource allocation.

In some cases, the set of interconnected physical and mobile infrastructures, networks, and smart sensors may include devices for capturing real-time data on asset parameters such as geolocation, temperature, humidity, vibrations, shock, and light. These devices may be strategically placed on or within goods, containers, vehicles, or other assets involved in the supply chain. The real-time data captured by these devices may provide a wealth of information about the status and conditions of the assets, enabling logistics operators to monitor and manage the assets effectively. For instance, geolocation data may provide real-time tracking of assets, temperature and humidity data may indicate the environmental conditions of the assets, and vibration and shock data may reveal any potential damage or mishandling of the assets. This comprehensive visibility into asset parameters may enhance operational efficiency, reduce risks, and improve customer satisfaction.

In other aspects, the physical and mobile infrastructures, networks, and smart sensors may be interconnected in a manner that facilitates seamless communication and data flow within the logistics network system. This interconnection may be achieved through various networking technologies and protocols, such as Ethernet, Wi-Fi, 5G, and LoRaWAN, among others. The interconnected infrastructures, networks, and sensors may collectively form a robust and resilient network that supports the efficient transmission and processing of data. This may enhance the responsiveness and adaptability of the logistics network system, enabling it to effectively handle dynamic changes in supply and demand, fluctuating market conditions, and other operational challenges.

In some aspects, the logistics network system may utilize real-time data to empower logistics operators with actionable insights and precise control over supply chain operations. This real-time data may be derived from various sources within the supply chain, such as IoT devices, GPS trackers, and other sensors embedded in the interconnected physical and mobile infrastructures, networks, and smart sensors. The real-time data may include information on asset parameters such as geolocation, temperature, humidity, vibrations, shock, and light. By analyzing this data, logistics operators may gain a comprehensive understanding of the status and conditions of goods in transit, enabling them to make informed decisions and take proactive measures to optimize logistics operations.

In some cases, the high-performance computing module of the logistics network system may be further configured to execute complex algorithms and deep learning models for rapid data processing and analytics. This may enable dynamic pricing, booking availability, and secure reservations across interconnected supply chains. For instance, the high-performance computing module may process real-time data on supply and demand, market conditions, and other relevant factors to generate dynamic pricing models. These models may adjust prices in real-time based on current market conditions, enhancing the responsiveness and competitiveness of the logistics network system. Similarly, the high-performance computing module may analyze real-time data on booking availability and capacity constraints to optimize resource allocation and ensure secure and efficient reservation processes. By leveraging the computational power of CPUs and GPUs, the high-performance computing module may rapidly process and analyze large volumes of data, enabling real-time decision-making and operational efficiency in the logistics network system.

In some aspects, the method for optimizing global supply chain operations may involve integrating multiple supply chain ecosystems into a cohesive network. This integration may be facilitated by a centralized operator, which consolidates, orchestrates, and streamlines logistics processes across the interconnected supply chain ecosystems. The centralized operator may utilize advanced algorithms and computational techniques to process and analyze data from various sources within the supply chain, enabling the operator to derive actionable insights and make informed decisions.

This method may also involve interconnecting physical and mobile infrastructures, networks, and smart sensors. These components may collectively form a robust and versatile framework that supports the operations of the logistics network system. The physical and mobile infrastructures may include various types of hardware and devices, such as servers, routers, switches, and mobile devices, which facilitate data transmission and communication within the network. The networks may include both wired and wireless networks, enabling seamless connectivity across diverse geographical locations and operational environments. The smart sensors may be IoT devices that capture real-time data on various parameters, such as location, temperature, humidity, vibrations, shock, and light. This data may provide valuable insights into the status and conditions of goods in transit, enabling proactive decision-making and efficient resource allocation.

In some cases, the method may leverage Artificial Intelligence of Things (AIoT) technologies to provide real-time visibility into dynamic pricing, booking availability, payment processing, smart contract execution, and traceability of physical and online goods. These AIoT technologies may include machine learning algorithms, neural networks, and other AI techniques, as well as IoT devices and sensors. The AIoT technologies may enable the module to process and analyze large volumes of data in real-time, facilitating rapid and accurate insights into various aspects of the supply chain. This may enhance the responsiveness and adaptability of the logistics network system, enabling it to effectively respond to changes in market conditions, customer demands, and other operational factors.

In other aspects, the method may utilize high-performance computing capabilities, including Central Processing Units (CPUs) and Graphics Processing Units (GPUs), to execute complex algorithms and deep learning models for rapid data processing and analytics. This operational variation may leverage the inherent computational power of CPUs and GPUs to handle the intensive computational demands of complex algorithms and deep learning models. By integrating these advanced computing capabilities into the logistics network system, the system may efficiently process large volumes of data, execute complex computations, and deliver real-time analytics. This may enhance the system's ability to make informed decisions, optimize logistics operations, and respond effectively to dynamic changes in the supply chain environment.

In some cases, the data processing module of the centralized operator may be further configured to generate predictive analytics based on the analyzed and interpreted data. This functional variation may involve the use of machine learning algorithms to analyze past data and trends within the supply chain and predict future patterns and behaviors. This predictive capability may enable the data processing module to anticipate changes in pricing, booking availability, payment processing, and other aspects of the supply chain, allowing logistics operators to make proactive decisions and adjustments. By leveraging machine learning algorithms, the data processing module may continuously learn and adapt to changing conditions, enhancing the efficiency and effectiveness of the logistics network system.

In other aspects, the high-performance computing capabilities of the logistics network system may further comprise a parallel processing module configured to simultaneously execute multiple complex algorithms and deep learning models. This functional variation may leverage the parallel processing capabilities of GPUs to accelerate the execution of complex algorithms and deep learning models. By harnessing the computational power of GPUs for parallel processing, the high-performance computing module may rapidly process and analyze large volumes of data, enabling real-time decision-making and operational efficiency in the logistics network system.

In some cases, the method may further comprise a step of tokenizing the real-time visibility data to secure and anonymize sensitive information. This process variation may involve the use of cryptographic techniques to replace sensitive data with non-sensitive equivalents, known as tokens. Tokenization may enhance the security of the logistics network system by protecting sensitive data from unauthorized access and breaches. By integrating tokenization into the method for optimizing global supply chain operations, the logistics network system may ensure the privacy and security of data while maintaining the integrity and usability of the data for operational purposes.

In some cases, the method for optimizing global supply chain operations may further comprise a step of tokenizing the real-time visibility data to secure and anonymize sensitive information. This process variation may involve the use of cryptographic techniques to replace sensitive data with non-sensitive equivalents, known as tokens. Tokenization may enhance the security of the logistics network system by protecting sensitive data from unauthorized access and breaches. By integrating tokenization into the method for optimizing global supply chain operations, the logistics network system may ensure the privacy and security of data while maintaining the integrity and usability of the data for operational purposes.

In this context, tokenization may be applied to various types of data within the logistics network system, such as pricing data, booking availability data, payment processing data, smart contract execution data, and traceability data of physical and online goods. For instance, sensitive pricing data may be tokenized to prevent unauthorized access to pricing information, while still allowing the logistics network system to perform dynamic pricing calculations based on the tokenized data. Similarly, booking availability data, payment processing data, and smart contract execution data may be tokenized to secure these sensitive operations while maintaining the functionality of the logistics network system.

In other aspects, the tokenization process may be automated and integrated into the AIoT module of the logistics network system. The AIoT module may be configured to automatically tokenize real-time visibility data as it is collected and processed, ensuring that sensitive data is secured at all times. This automated tokenization may enhance the efficiency and reliability of the logistics network system, as it reduces the risk of human error and ensures consistent application of security measures across the system.

In summary, the integration of tokenization into the method for optimizing global supply chain operations may enhance the security and privacy of the logistics network system, while maintaining the integrity and usability of the data for operational purposes. This may contribute to the overall efficiency, responsiveness, and transparency of the logistics network system, enabling it to effectively manage and optimize global supply chain operations.

In some aspects, the method for optimizing global supply chain operations may involve a step of synchronizing the multiple supply chain ecosystems based on predefined criteria. This synchronization may be facilitated by the centralized operator, which integrates and synchronizes multiple supply chain ecosystems into a superstructure capable of large-scale transmission. This synchronization may enable seamless communication and information flow between clients and suppliers, enhancing collaboration and transparency across the supply chain. For instance, the centralized operator may coordinate the movement of goods, manage inventory levels, and oversee payment processing and contract execution across the interconnected supply chains. By synchronizing these diverse operations, the centralized operator may enhance the overall efficiency and effectiveness of the logistics network system.

In some cases, the synchronization may include large-scale transmission capabilities to connect clients and suppliers through the interconnected physical and mobile infrastructures, networks, and smart sensors. This variation may be particularly beneficial in scenarios where the supply chain ecosystems are already interconnected but require further optimization and coordination. The large-scale transmission capabilities may facilitate the exchange of data and information across the interconnected supply chain ecosystems, enhancing the overall efficiency and effectiveness of the logistics network system. By enabling seamless communication and information flow, the logistics network system may enhance operational efficiency, reduce redundancies, and enhance responsiveness to changes in supply and demand.

In other aspects, the synchronization process may be automated and integrated into the AIoT module of the logistics network system. The AIoT module may be configured to automatically synchronize the multiple supply chain ecosystems as they are collected and processed, ensuring that all supply chain operations are aligned and coordinated at all times. This automated synchronization may enhance the efficiency and reliability of the logistics network system, as it reduces the risk of disjointed operations and ensures consistent application of synchronization measures across the system.

In summary, the integration of synchronization into the method for optimizing global supply chain operations may enhance the efficiency, responsiveness, and transparency of the logistics network system, enabling it to effectively manage and optimize global supply chain operations. This may contribute to the overall efficiency, responsiveness, and transparency of the logistics network system, enabling it to effectively manage and optimize global supply chain operations.

In an alternative design of the logistics network system, the centralized operator may be configured to consolidate, orchestrate, and streamline logistics processes, instead of integrating multiple supply chain ecosystems into a cohesive network. This variation may be particularly beneficial in scenarios where the supply chain ecosystems are already interconnected but require further optimization and coordination. The centralized operator in this configuration may act as a control center, managing and optimizing logistics processes across the interconnected supply chain ecosystems. This may lead to improved operational efficiency, reduced redundancies, and enhanced responsiveness to changes in supply and demand.

In some aspects, the centralized operator may consolidate logistics processes by bringing together disparate operations into a unified framework. This consolidation may reduce redundancies, eliminate inefficiencies, and streamline workflows, leading to improved operational efficiency and cost savings. For instance, the centralized operator may consolidate inventory management, order fulfillment, and delivery scheduling processes across multiple supply chain ecosystems, enabling a more efficient and coordinated approach to logistics management.

In some cases, the centralized operator may orchestrate logistics processes by coordinating and directing the various operations within the supply chain. This orchestration may enhance the responsiveness and adaptability of the logistics network system, enabling it to effectively respond to changes in market conditions, customer demands, and other operational factors. For instance, the centralized operator may orchestrate the movement of goods, manage inventory levels, and oversee payment processing and contract execution across the interconnected supply chain ecosystems.

In other aspects, the centralized operator may streamline logistics processes by simplifying and optimizing workflows, reducing complexities, and enhancing efficiency. This streamlining may lead to faster processing times, improved accuracy, and reduced operational costs. For instance, the centralized operator may streamline order fulfillment processes by automating tasks, optimizing workflows, and leveraging AIoT technologies for real-time visibility and predictive analytics.

In summary, the alternative design of the logistics network system, where the centralized operator is configured to consolidate, orchestrate, and streamline logistics processes, may enhance the efficiency, responsiveness, and transparency of the logistics network system. This may contribute to the overall efficiency, responsiveness, and transparency of the logistics network system, enabling it to effectively manage and optimize global supply chain operations.

In an alternative design of the logistics network system, the Artificial Intelligence of Things (AIoT) module may be configured to enhance efficiency, responsiveness, and transparency across supply chain networks, instead of providing real-time visibility into dynamic pricing, booking availability, payment processing, smart contract execution, and traceability of physical and online goods. This variation may be particularly beneficial in scenarios where the primary objective is to optimize the overall performance of the supply chain networks, rather than focusing on specific aspects such as pricing or booking availability.

In some aspects, the AIoT module may leverage advanced AI algorithms and IoT technologies to enhance efficiency across the supply chain networks. This may involve optimizing resource allocation, streamlining workflows, and reducing operational inefficiencies. For instance, the AIoT module may utilize machine learning algorithms to analyze data from various sources within the supply chain, identify patterns and trends, and generate recommendations for improving operational efficiency.

In some cases, the AIoT module may enhance responsiveness across the supply chain networks. This may involve real-time monitoring of supply chain operations, rapid response to changes in market conditions or customer demands, and proactive adjustment of logistics processes. For instance, the AIoT module may utilize IoT devices and sensors to monitor the status and conditions of goods in transit, and AI algorithms to predict potential disruptions or delays, enabling logistics operators to take proactive measures to mitigate these issues.

In other aspects, the AIoT module may enhance transparency across the supply chain networks. This may involve providing clear and accurate information about the status and progress of logistics operations, enabling stakeholders to make informed decisions and maintain accountability. For instance, the AIoT module may utilize blockchain technology to create a transparent and immutable record of transactions, contracts, and other logistics operations, enhancing trust and confidence among stakeholders.

In summary, the alternative design of the logistics network system, where the AIoT module is configured to enhance efficiency, responsiveness, and transparency across supply chain networks, may contribute to the overall performance and competitiveness of the logistics network system. This may enable the logistics network system to effectively manage and optimize global supply chain operations, meeting the diverse and dynamic demands of today's global marketplace.

The instant technology represents a transformative approach to supply chain management, leveraging the convergence of AI, IoT, and AIoT to create an intelligent, efficient, and interconnected logistics network that redefines global trade and commerce in the digital age.

The instant disclosure may be further described as a logistics network system, comprising:
a. a centralized operator configured to integrate multiple supply chain ecosystems into a cohesive network;
b. a set of interconnected physical and mobile infrastructures, networks, and smart sensors;
c. an Artificial Intelligence of Things (AIoT) module configured to provide real-time visibility into dynamic pricing, booking availability, payment processing, smart contract execution, and traceability of physical and online goods; and
d. a high-performance computing module comprising Central Processing Units (CPUs) and Graphics Processing Units (GPUs) configured to execute complex algorithms and deep learning models for rapid data processing and analytics.

The logistics network system of the instant disclosure, wherein the centralized operator is further configured to synchronize the multiple supply chain ecosystems to facilitate seamless communication and information flow.

The logistics network system of the instant disclosure, wherein the synchronization includes large-scale transmission capabilities to connect clients and suppliers through the interconnected physical and mobile infrastructures, networks, and smart sensors.

The logistics network system of the instant disclosure, wherein the AIoT module is further configured to enhance efficiency, responsiveness, and transparency across the supply chain networks.

The logistics network system of the instant disclosure, wherein the high-performance computing module is further configured to execute complex algorithms and deep learning models for rapid data processing and analytics, enabling dynamic pricing, booking availability, and secure reservations across interconnected supply chains.

The logistics network system of the instant disclosure, wherein the set of interconnected physical and mobile infrastructures, networks, and smart sensors includes devices for capturing real-time data on asset parameters such as geolocation, temperature, humidity, vibrations, shock, and light.

The logistics network system of the instant disclosure, wherein the real-time data is used to empower logistics operators with actionable insights and precise control over supply chain operations.

A method for optimizing global supply chain operations, comprising the steps of:
a. integrating multiple supply chain ecosystems into a cohesive network using a centralized operator;
b. interconnecting physical and mobile infrastructures, networks, and smart sensors;
c. leveraging Artificial Intelligence of Things (AIoT) technologies to provide real-time visibility into dynamic pricing, booking availability, payment processing, smart contract execution, and traceability of physical and online goods; and
d. utilizing high-performance computing capabilities, including Central Processing Units (CPUs) and Graphics Processing Units (GPUs), to execute complex algorithms and deep learning models for rapid data processing and analytics.

The method of the instant disclosure, wherein the centralized operator further comprises a data processing module configured to analyze and interpret data from the interconnected physical and mobile infrastructures, networks, and smart sensors.

The method of the instant disclosure, wherein the data processing module is further configured to generate predictive analytics based on the analyzed and interpreted data.

The method of the instant disclosure, wherein the AIoT module further comprises a machine learning algorithm configured to adapt and optimize the real-time visibility based on historical data and trends.

The method of the instant disclosure, wherein the high-performance computing capabilities further comprise a parallel processing module configured to simultaneously execute multiple complex algorithms and deep learning models.

The method of the instant disclosure, further comprising a step of tokenizing the real-time visibility data to secure and anonymize sensitive information.

The method of the instant disclosure, wherein the integrating step further comprises a step of synchronizing the multiple supply chain ecosystems based on predefined criteria.

A logistics network system, comprising:
a. a centralized operator configured to consolidate, orchestrate, and streamline logistics processes;
b. a set of interconnected physical and mobile infrastructures, networks, and smart sensors;
c. an Artificial Intelligence of Things (AIoT) module configured to enhance efficiency, responsiveness, and transparency across supply chain networks; and
d. a high-performance computing module comprising Central Processing Units (CPUs) and Graphics Processing Units (GPUs) configured to execute complex algorithms and deep learning models for rapid data processing and analytics.

The logistics network system of the instant disclosure, wherein the centralized operator is further configured to synchronize the multiple supply chain ecosystems to facilitate seamless communication and information flow.

The logistics network system of the instant disclosure, wherein the synchronization includes large-scale transmission capabilities to connect clients and suppliers through the interconnected physical and mobile infrastructures, networks, and smart sensors.

The logistics network system of the instant disclosure, wherein the AIoT module is further configured to enhance efficiency, responsiveness, and transparency across the supply chain networks by utilizing machine learning algorithms.

The logistics network system of the instant disclosure, wherein the high-performance computing module is further configured to execute complex algorithms and deep learning models for rapid data processing and analytics, enabling dynamic pricing, booking availability, and secure reservations across interconnected supply chains.

The logistics network system of the instant disclosure, wherein the set of interconnected physical and mobile infrastructures, networks, and smart sensors includes devices for capturing real-time data on asset parameters such as geolocation, temperature, humidity, vibrations, shock, and light, and wherein the real-time data is used to empower logistics operators with actionable insights and precise control over supply chain operations.

The convergence of Artificial Intelligence (AI), Internet of Things (IoT), and specifically, Artificial Intelligence of Things (AIoT), through the instant disclosure (the instant disclosure) heralds a new era of supply chain optimization. AI technologies empower supply chain managers to process vast datasets, derive actionable insights, and transform global supply chain operations. With AI embedded in the instant disclosure, managers gain visibility into pricing, real-time asset tracking, and predictive capabilities for proactive decision-making across road, air, and sea freight operations.

IoT complements AI within the instant disclosure by providing a network of interconnected devices and sensors that generate real-time data about assets, shipments, and environmental conditions. This data fuels AI-driven analytics, enabling precise monitoring, tracking, and control over supply chain activities. The integration of AI with IoT (AIoT) empowers the instant disclosure to analyze complex supply chain data, enhance adaptability, and automate critical processes like payments, credit applications, and smart contracts through geofencing and Service Level Agreement fulfillment.

By harnessing AIoT technologies, the instant disclosure (the instant disclosure) optimizes resource allocation, streamlines logistics operations, and enhances global supply chain visibility, driving economic growth and resilience in trade networks. This convergence of AI, IoT, and AIoT within the instant disclosure signifies a paradigm shift towards intelligent, efficient, and interconnected supply chain networks that redefine global trade and commerce in the digital age.

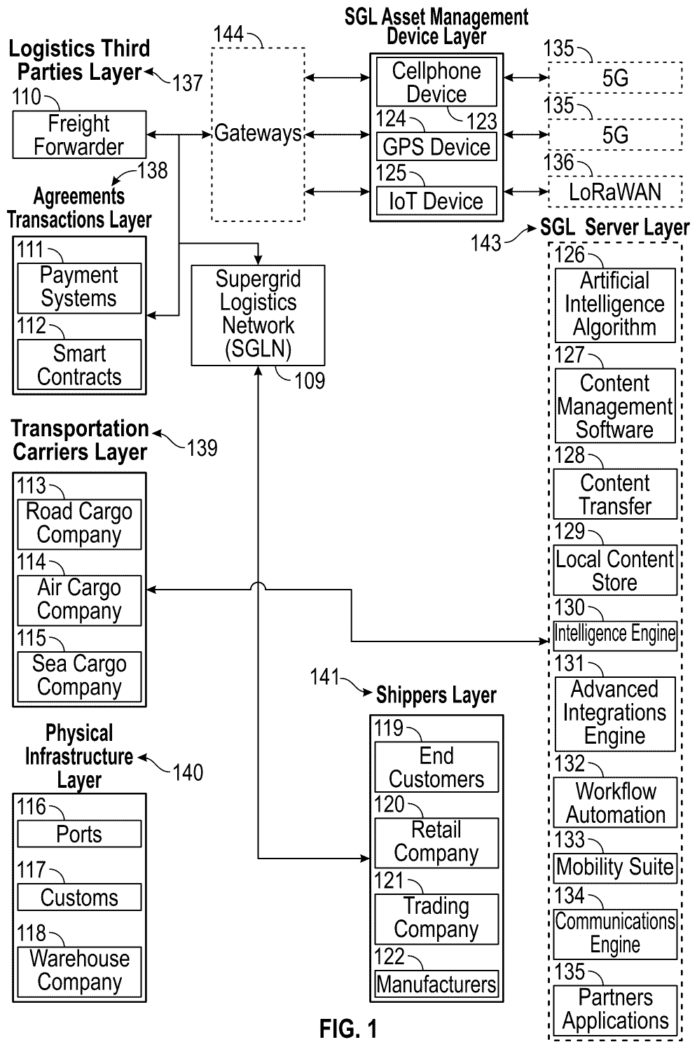

Referring now to the drawings FIG. 1-9, and more particularly to FIG. 1, there is shown the instant disclosure 109 is illustrated as a multifaceted system comprising interconnected layers that facilitate seamless supply chain operations in a scalable manner. At the core of this network is the Agreement Transactions Layer 138, which acts as the backbone for global connectivity and scalability. This layer integrates sophisticated Payment Systems 111 with Smart Contracts 112, providing a secure and automated framework for executing transactions and enforcing contractual agreements. Supported by the powerful capabilities of the instant disclosure Logistics Server Layer 143, which includes Artificial Intelligence Algorithms 126, Content Management Software 127, Workflow Automation 132, the Agreement Transactions Layer ensures efficient processing and validation of transactions across the network. Using more of the motor than the instant disclosure Logistics Server Layer 143 is with the rest of the components built and used like Content Transfer, Local Content Store 129, Intelligence Engine 130, Advanced Integrations Engine 131, and the rest of the components of the layer.

As goods progress through the supply chain, they interact with the Transportation Carriers Layer 139, encompassing Road, Air, and Sea Cargo companies. These carriers leverage the Physical Infrastructure Layer 140, consisting of ports, customs, and warehouse facilities, to facilitate the movement and storage of goods. The instant disclosure Logistics Asset Management Device Layer 142 plays a crucial role in tracking and managing assets using a variety of devices such as cellphones, GPS devices, and IoT sensors. These devices communicate data through Gateways equipped with 5G and LoRa WAN technologies, ensuring real-time visibility and control over supply chain activities.

The inclusion of the Logistics Third Party Layer 137, which includes Freight Forwarders, further enhances the network's capabilities by leveraging existing industry expertise and relationships. This layer fosters cultural and social integration within the supply chain ecosystem, enabling broader market access and scalability for participants. Through the orchestrated interplay of these interconnected layers and technologies—supported by API calls, transaction records, shipment IDs, service agreements, and validates data—the instant disclosure optimizes resource allocation, streamlines logistics operations, and enhances overall supply chain visibility on a global scale.

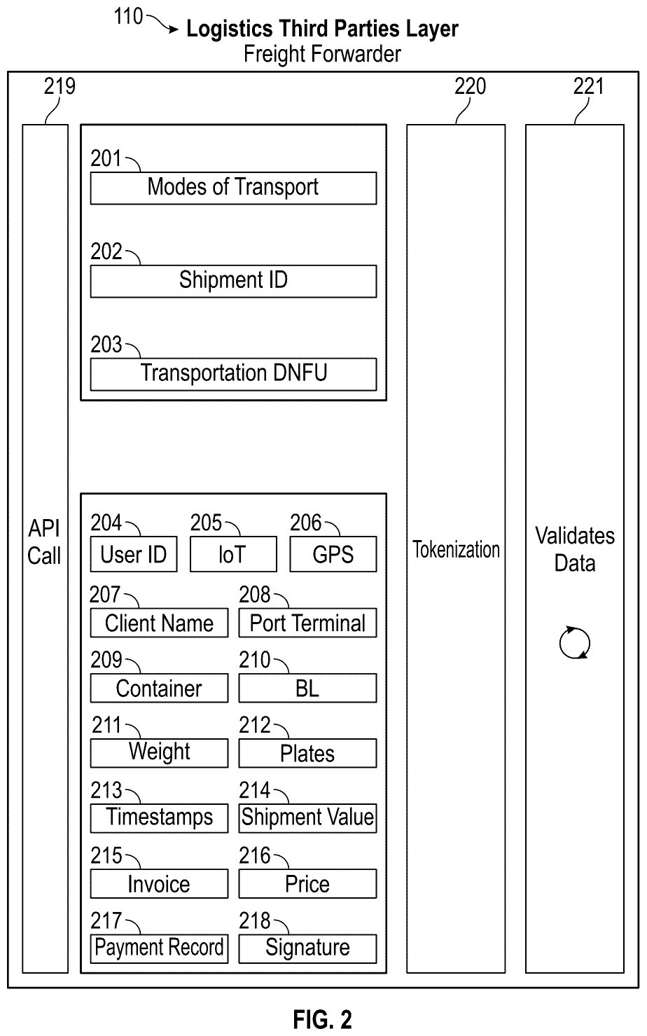

As shown in FIG. 2. a cultural part of the network is shown, which is The Logistics Third Parties Layer. Up to this point the Freight Forwarder, also known as a 4PL or logistics agent, has functioned as a small network for local logistics markets. They enable credit services, coordinate shipment in their localities or even worldwide. They connect different modes of transport and follow up with shippers' needs on a small scale. To make them part of the instant disclosure one needs to consider their actual role. Unto the system and method in the instant disclosure connecting their ERPs or providing them with the system's through an API Call 219 they may both share and receive the information of the Modes of Transport 201 of their shipment, the Shipment ID 202 for track and trace and the Transportation DNFU 203, which is the Transportation Data Node For Utilization which connects the information of the different modes of transport per shipment and BL (Bill of Lading) 210. The User ID 204, which contemplates the client with the Client Name 207, with the above labels and data considers the IoT 205 and GPS 206 devices. Also, the Port Terminal 208, container 209, Weight 211 of the Container 209. The Plates 212 of the Modes of Transport's 201 carrier. Finally, unto the Timestamps 213 for traceability and accomplishing the delivery of the cargo. For the Price 216, Invoice 215, Signature 218 and Payment Record 217 to take place.

The first layer encompasses a Logistics Third Parties Layer, which includes a Freight Forwarder 110. Another layer is those who mainly move the cargo from different locations which are the Transportation Carriers Layer including Road Cargo Company 113, Air Cargo Company 114, and Sea Cargo Company 115. The Physical Infrastructure Layer with Ports 116, Customs 117, and Warehouse Company 118. The Shippers Layer includes End Customers 119, Retail Company 120, Trading Company 121, and Manufacturers 122. The instant disclosure Logistics Asset Management Device Layer considering Cell Phone Device 123, GPS Device 124, and IoT Device 125. Receiving information through any suitable communication protocol including but not limited to 5G 135 and LoRa WAN 136. Finally, the instant disclosure Logistics Server Layer that benefits from an Artificial Intelligence Algorithm 126, Content Management Software 127, Content Transfer 128, Local Content Store 129, Intelligence Engine 130, Advanced Integrations Engine 131, Workflow Automation 132, Mobility Suite 133, Communications Engine 134, and Partners Application 135.

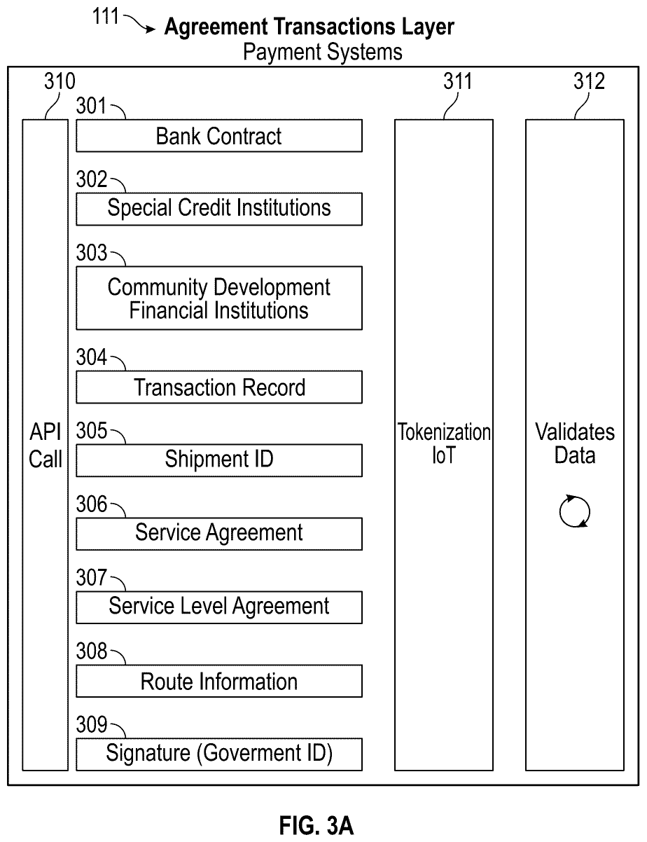

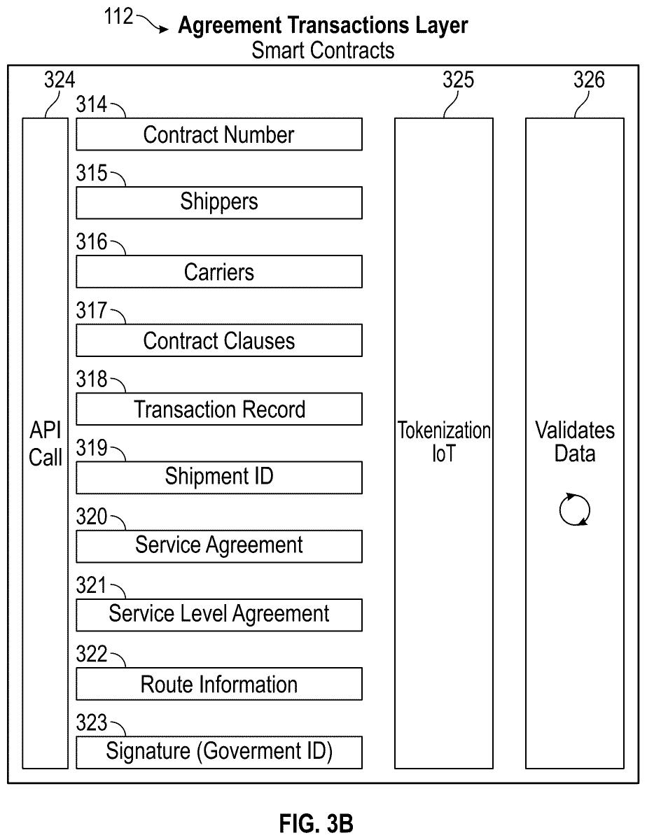

As shown in FIG. 3A. the Agreement Transaction Layer within the instant disclosure functions as the robust payment system orchestrating transactions and interactions using various integrated components. This layer facilitates API calls 310, the other layers of the instant disclosure and external systems for data exchange and validation. It utilizes Bank Contracts 301 and interfaces with Special Credit Institutions 302 and Community Development Financial Institutions 303 for secure fund transfers, credit applications and regulatory compliance. Each transaction is recorded within the network, generating a comprehensive Transaction Record 304 tied to specific shipment IDs 305, service agreements 306, and service level agreements 307.

Route information 308 is validated and managed within this layer to ensure accurate and efficient movement of goods. Furthermore, the layer incorporates Signature 309 validation using government IDs to authenticate and authorize transactions. Tokenization of IoT 311 data is employed to secure and anonymize sensitive information, enhancing data integrity and privacy. The layer Validates Data 312 integrity and authenticity throughout the transaction lifecycle, ensuring the accuracy and reliability of each transaction within the network. This interconnected system optimizes payment processes, enhances security, and fosters transparency and compliance across the instant disclosure Logistics Network.

As shown in FIG. 3B. the Smart Contracts integrate sophisticated functionalities to manage transactions and enforce contractual agreements within the instant disclosure. This leverages API calls 324 to enable seamless communication with external systems and stakeholders such as shippers 315 and carriers 316. Smart contracts are employed to automate contract execution based on predefined contract clauses 317, ensuring compliance and transparency throughout the transaction process. Each transaction and contract number 314 are recorded in a comprehensive transaction record 318 linked to specific shipment IDs 319, service agreements 320, and service level agreements 321.

Route information 322 and contract numbers 314 are validated and managed within this layer to facilitate efficient and accurate routing of goods and services. Additionally, the layer incorporates signature 323 validation using government IDs to authenticate and authorize contractual agreements. IoT data is tokenized 325 to create an identity per shipment and contract to secure payment by the service level agreement 321. Enhancing security and privacy, ensuring that sensitive information is protected throughout the transaction lifecycle. The layer validates data 326 providing a reliable foundation for transactional operations and contractual enforcement within the network. This interconnected system streamlines contract management, enhances security, and fosters trust among participants in the instant disclosure.

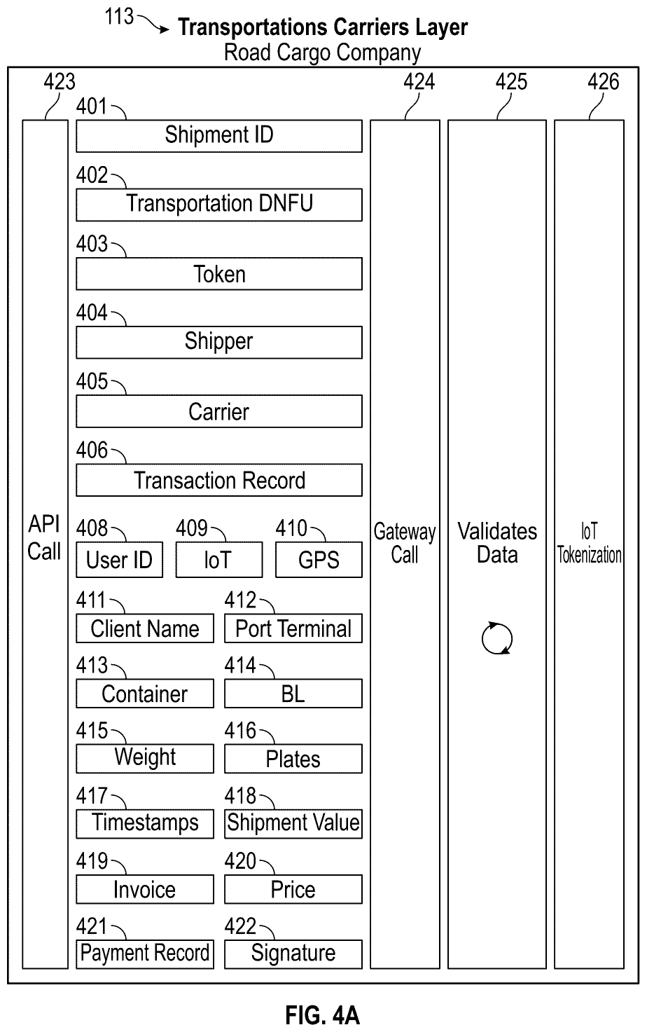

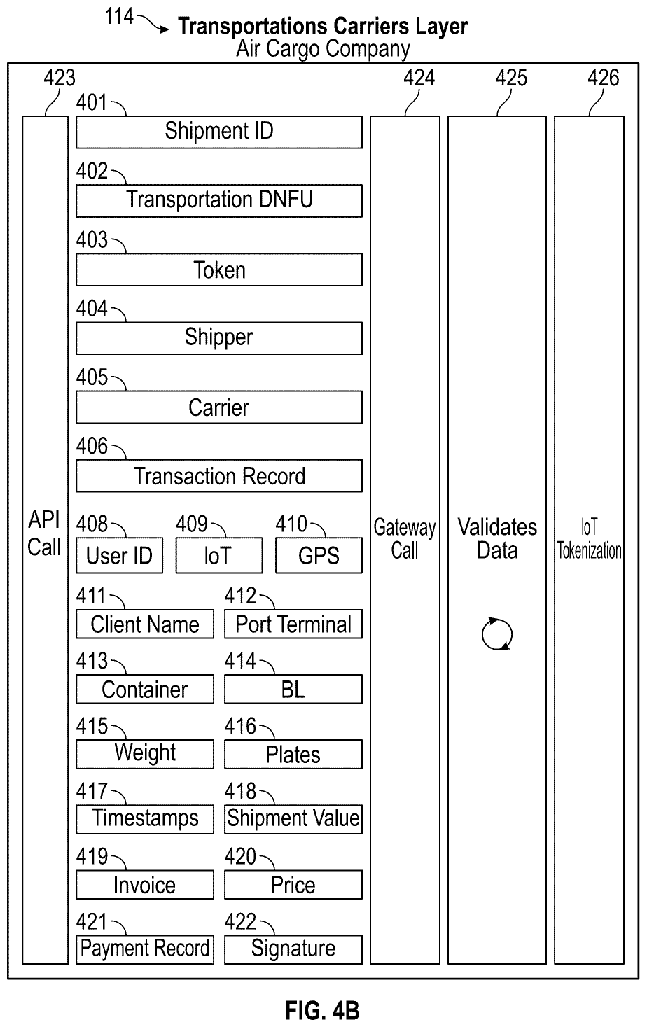

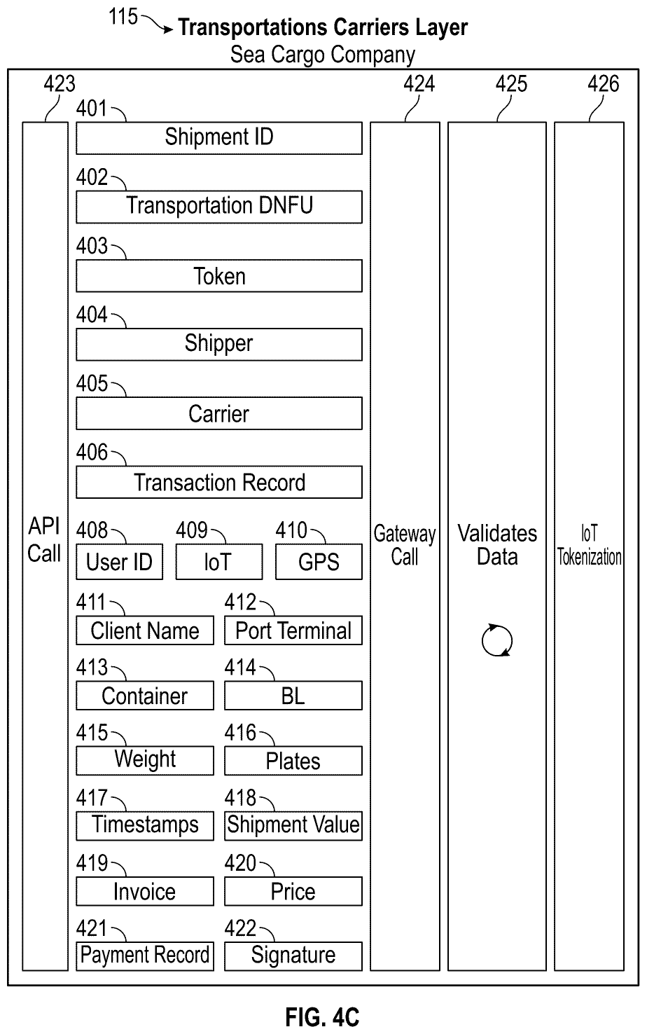

The instant disclosure System and Method the Transportation Carriers Layer is shown in FIG. 4A, FIG. 4B and FIG. 4C shows how the logistics network integrates various types of carriers, including road cargo companies 4A, air cargo companies 4B, and sea cargo companies 4C, each playing a crucial role in the transportation of goods. Road cargo companies facilitate ground transportation, air cargo companies manage air transport, and sea cargo companies oversee maritime shipping. These carriers interact within the network to ensure seamless transitions between modes of transport, optimizing the supply chain's efficiency and effectiveness.

Within this layer, key terms and functionalities are employed to manage transportation operations effectively. API calls 423 facilitate communication and data exchange between carriers 405, shippers 404, and other stakeholders, enabling real-time updates and coordination. Shipment IDs 401 are used to identify and track shipments throughout the transportation process. Transportation data nodes for utilization (DNFU) 402 determine the most suitable mode of transport based on predefined criteria, ensuring optimal routing and resource allocation. Creating transaction records 406.

IoT 409 devices and GPS 410 devices are utilized to gather real-time data on shipments, including location, environmental conditions, and status. This data is tokenized and secured using IoT tokenization techniques 426 for automatic payments. Other essential terms like client names 411, port terminals 412, containers 413, bill of lading (BL) 414, weights 415, timestamps 417, shipment values 418, invoices 419, prices 420, and payment records 421 are managed within the transportation carrier's layer. Validated data with the server and rest of the internal layers of the instant disclosure 425 ensures accuracy and reliability throughout the transportation process, enhancing transparency and accountability within the system. Gateway calls 424 enable seamless integration with external systems, further enhancing connectivity and interoperability across the network.

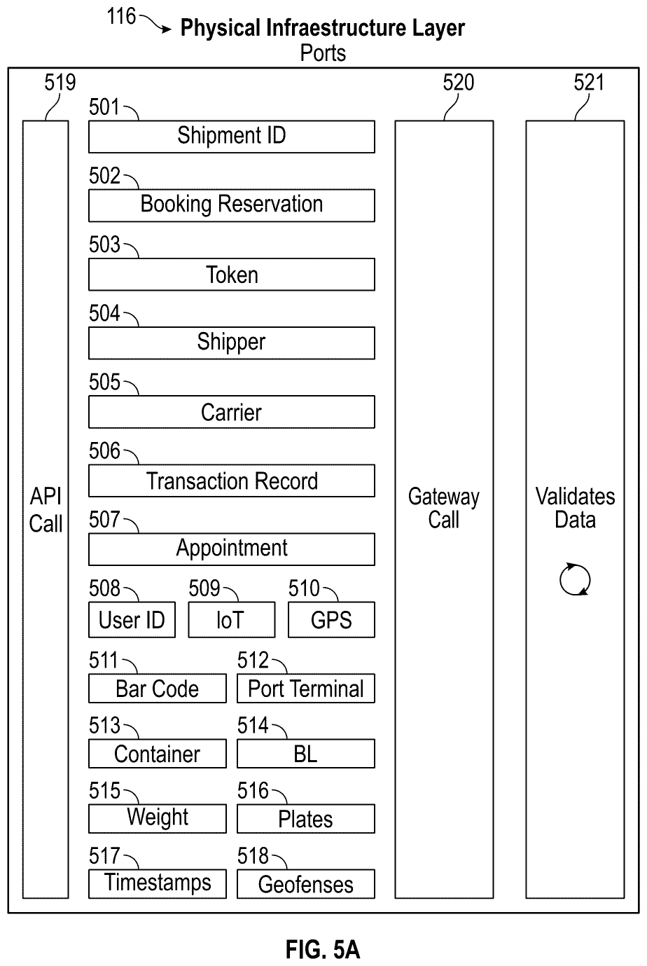

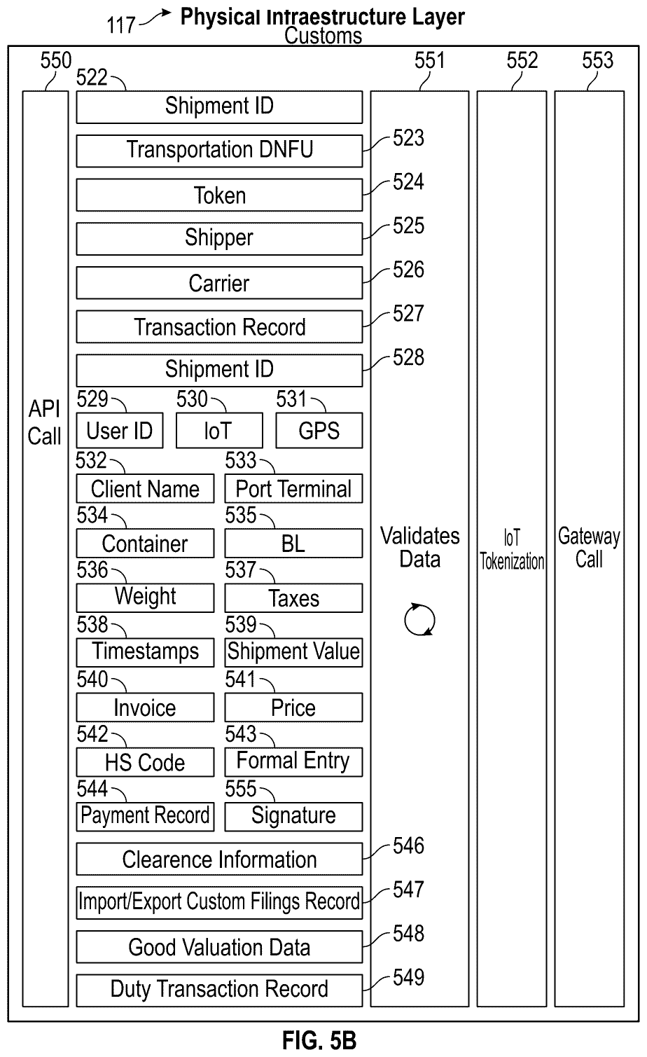

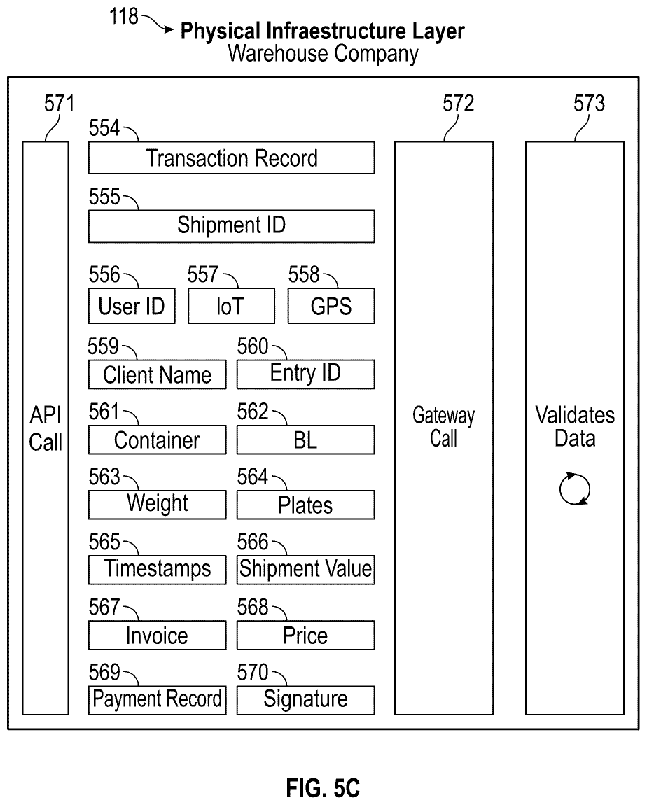

As shown in FIG. 5A, FIG. 5B and FIG. 5C the physical infrastructure layer of the logistics network encompasses Ports, Customs, and Warehouse companies, which play vital roles in the final stages of shipment delivery and handling. These entities interact closely to ensure smooth and efficient processing of goods.

Ports serve as key hubs for incoming and outgoing shipments, facilitating the transfer of goods between different modes of transport, such as sea and land transport. Customs agencies oversee the clearance of shipments, ensuring compliance with import/export regulations, duties, and taxes. Warehouse companies manage storage and distribution of goods upon arrival, providing temporary or long-term storage solutions based on customer requirements.

Within this layer, various terms and functionalities are utilized to manage shipment processing and documentation. API calls 519 enables seamless communication and data exchange between ports, customs agencies, warehouse companies, and other stakeholders. Shipment IDs 501 uniquely identify each shipment, facilitating tracking and traceability throughout the logistics process. Transportation Data Nodes for Utilization 523 optimize routing decisions, determining the most efficient mode of transport based on predefined criteria.

IoT 509 devices and GPS 510 devices are deployed to monitor shipments in real-time, capturing data on location, environmental conditions, and status. Data collected from IoT 530 devices is tokenized for security using IoT tokenization 552 techniques, ensuring sensitive information remains protected. Other critical terms such as client names 532, container details 534, bill of lading (BL) 535, shipment weights 536, timestamps 538, shipment values 539, invoices 540, prices 541, and payment records 544 are managed and processed within this layer.

Additionally, customs-related terms like HS codes 542, formal entry requirements 543, clearance information 546, import/export customs filing records 547, goods valuation data 548, duty transaction records 549, geofences 518, barcodes 511, appointment scheduling 507, and booking reservations 502 are essential components managed by ports and customs agencies to facilitate smooth and compliant shipment processing. The integration of these entities and functionalities within FIG. 5 ensures efficient and transparent handling of shipments from arrival to final delivery at the Warehouse with the Entry ID 560.

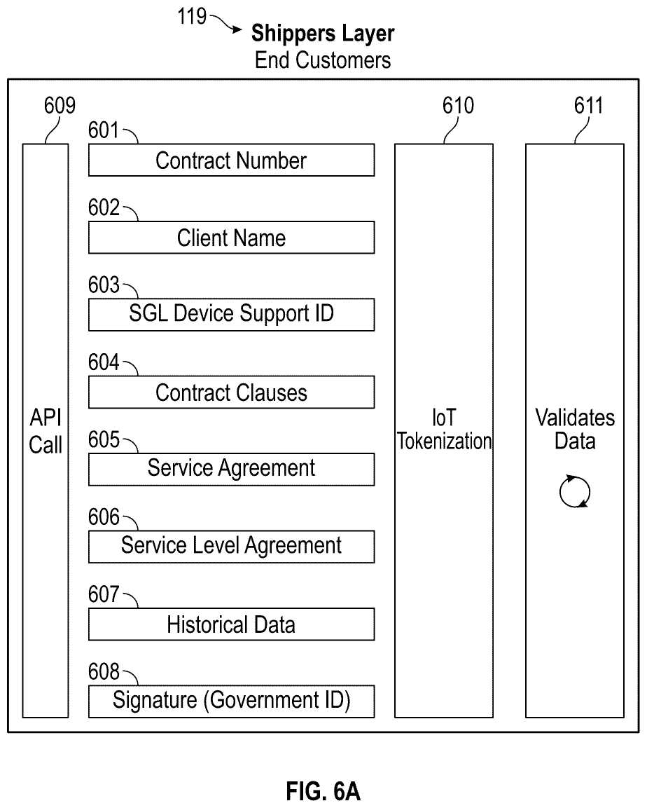

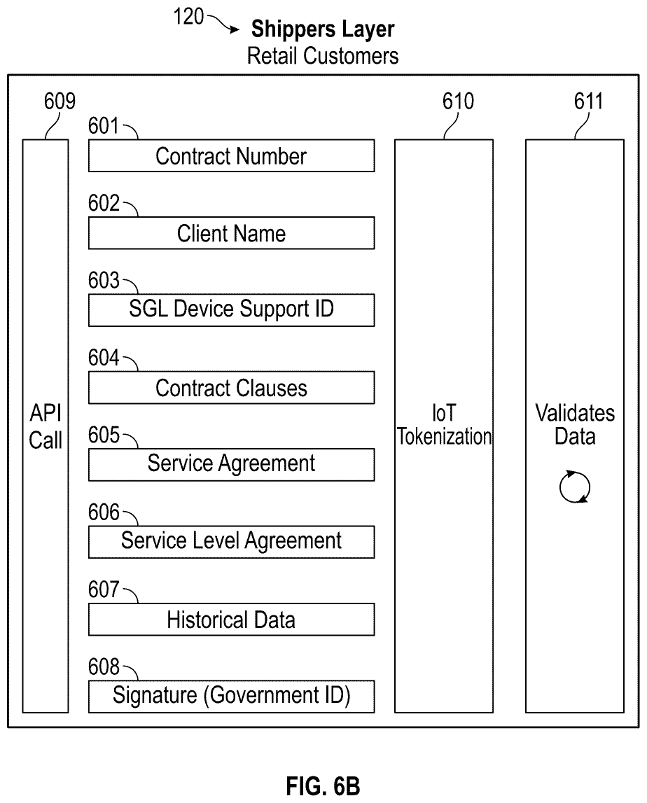

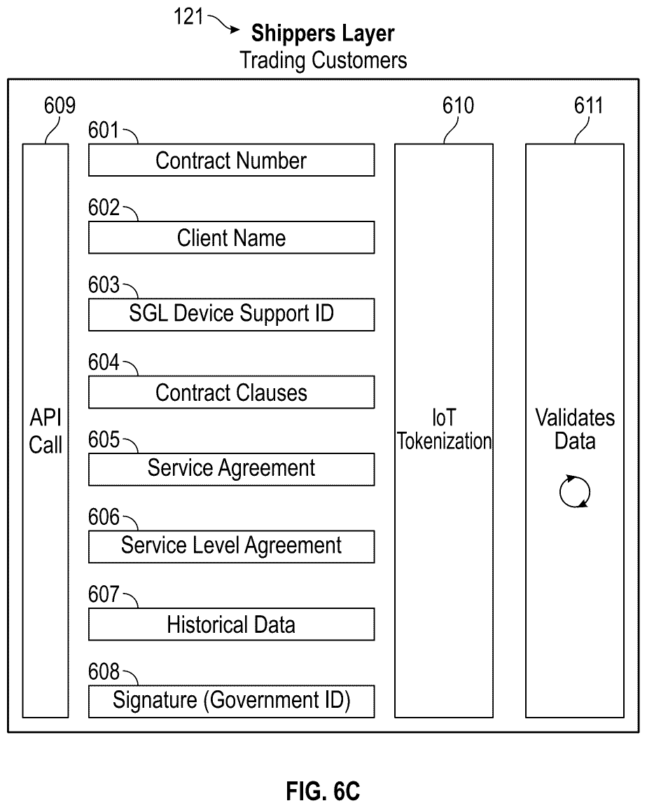

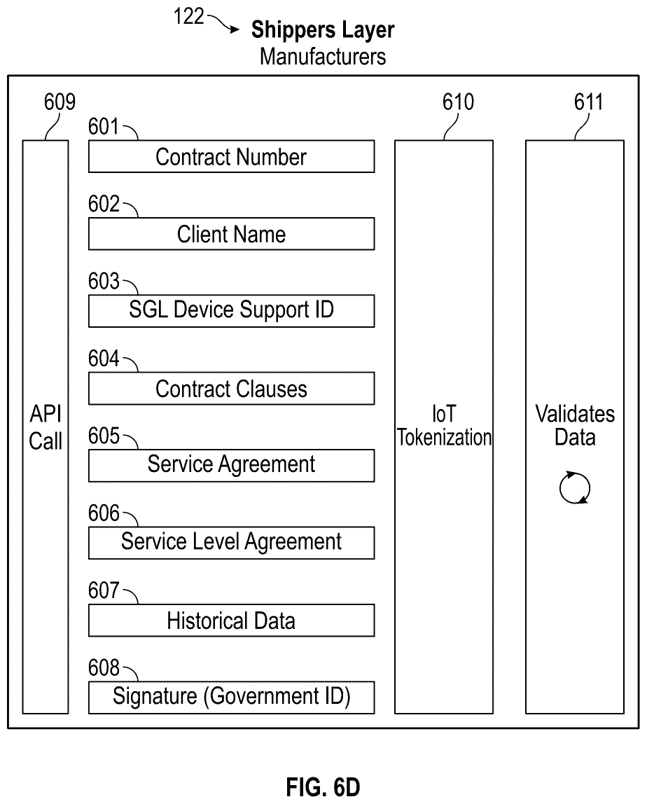

As shown in FIG. 6A, FIG. 6B, FIG. 6C and FIG. 6D of the Shipper Layer of the instant disclosure (the instant disclosure), various stakeholders including end customers, retail companies, trading companies, and manufacturers interact with the system to manage cargo movements and logistics operations. These different types of shippers have distinct needs but share common data attributes that drive efficient supply chain management.

These shippers rely on the instant disclosure to access real-time data and historical insights through API calls 609, facilitating tracking, validation, and decision-making. They engage in service agreements 605, utilize contract numbers 601, and manage contractual clauses 604 to govern logistics transactions and operations. The instant disclosure supports these interactions by providing a standardized framework for managing shipments, establishing service levels, and ensuring compliance through IoT tokenization 610 and data validation 611.

Key data attributes such as client names 602, contract details, historical data 607, and signature with government IDs 608 are critical for all shippers within the Shipper Layer. This unified approach enables seamless interoperability and efficient cargo management across different sectors of the supply chain, enhancing transparency, reliability, and performance throughout the instant disclosure. An important part is the methods used through both hardware and software like the instant disclosure Logistics Device Support ID 603 that bridges the transmitted information with the Shipments moved through Geofences, with more data needed to close cycles within the instant disclosure.

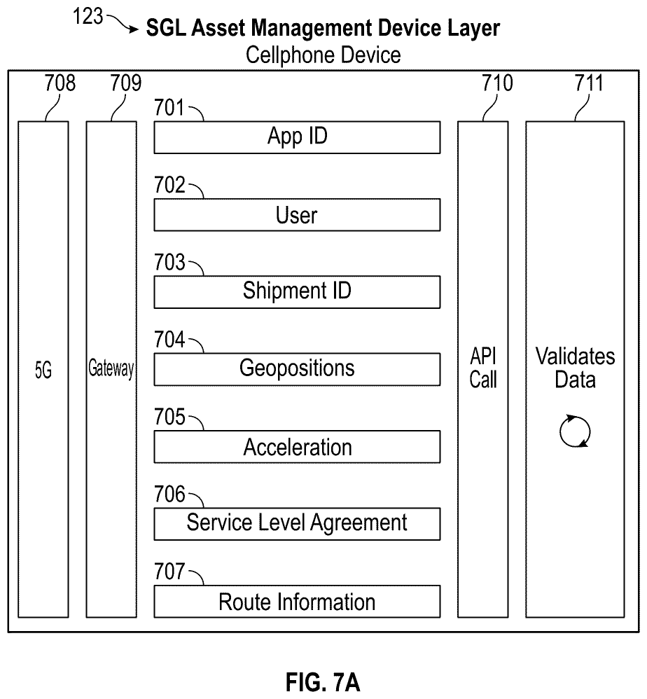

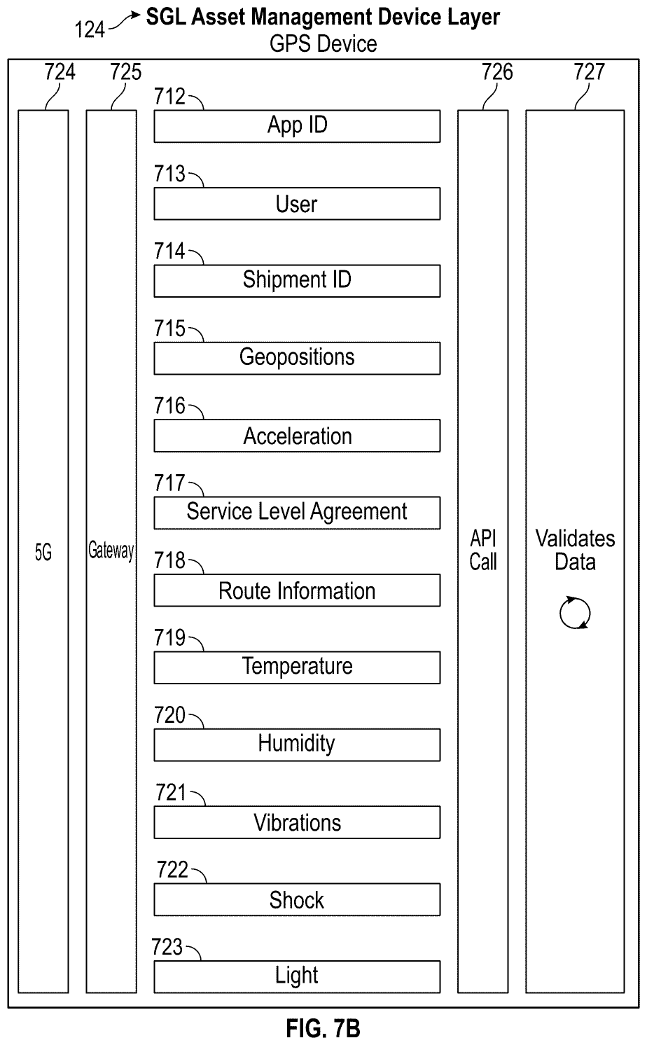

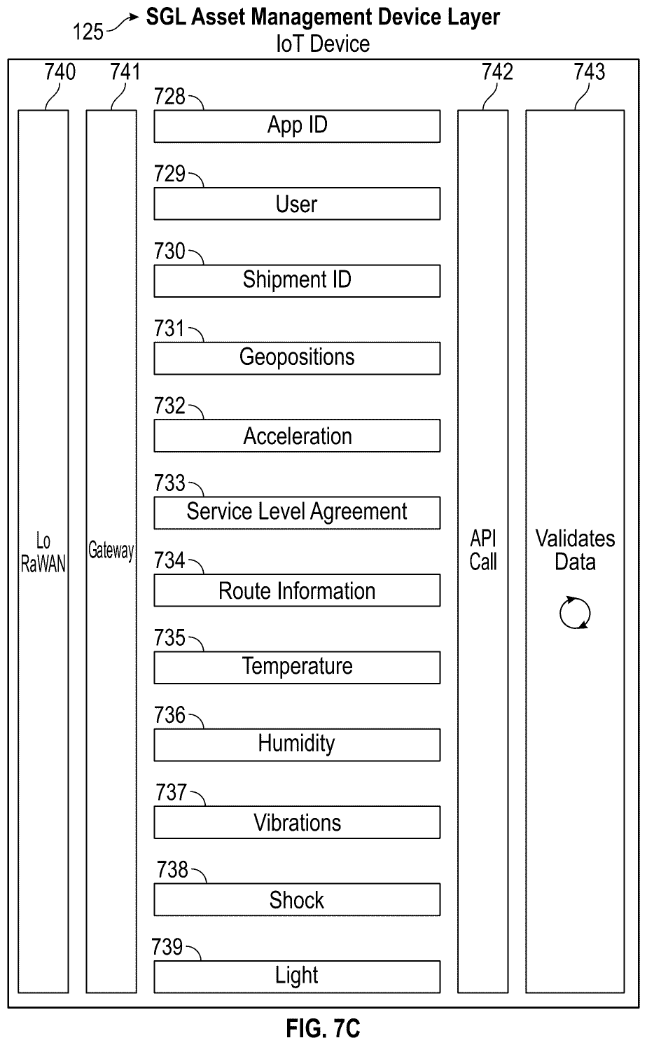

FIG. 7A, FIG. 7B and FIG. 7C illustrate the instant disclosure Logistics Asset Management Device Layer, where various devices utilize the 5G and LoRa WAN networks to transmit essential data about cargo movements along the supply chain. These devices play a critical role in ensuring the instant disclosure (the instant disclosure) remains interconnected and provides accurate data for predictions and real-time visibility.

These devices include smart devices, cellphone devices, GPS devices, and IoT devices. The cellphone device operates within the 5G network 708, utilizing a gateway 709 and specific application IDs (App ID) 701 for user identification 702. It captures geopositions 704, acceleration 705, and validates data 711 based on predefined service level agreements (SLAs) 706 and route information. API 710 calls are made to exchange information seamlessly within the instant disclosure ecosystem. Similarly, the GPS device communicates over any suitable communication protocol including and not limited to 5G 724, identifying users 713 and shipments through App IDs 712 and Shipment IDs 714. It records geopositions 715, acceleration 716, as well as temperature 719, humidity 720, vibrations 721, shock 722, and light conditions 723. The GPS device validates data 727 against SLAs 717 and route information 718 using API calls 726. The IoT device, on the other hand, operates on the Lora WAN network 740 with a gateway 741 and assigned App IDs 728. It captures geo positions 731, acceleration 732, and environmental data like temperature 735, humidity 736, vibrations 737, shock 738, and light 739. The IoT device communicates within the instant disclosure through API calls 742 and validates data 743 based on SLAs 733 and route information 734. These interconnected devices contribute critical data to the instant disclosure, enhancing supply chain visibility and operational efficiency.

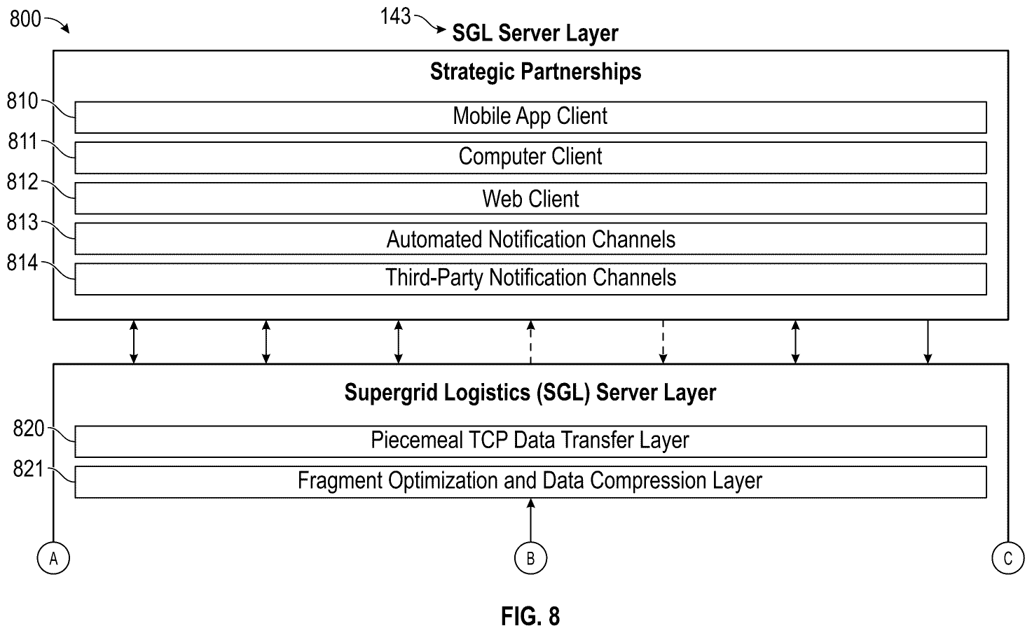

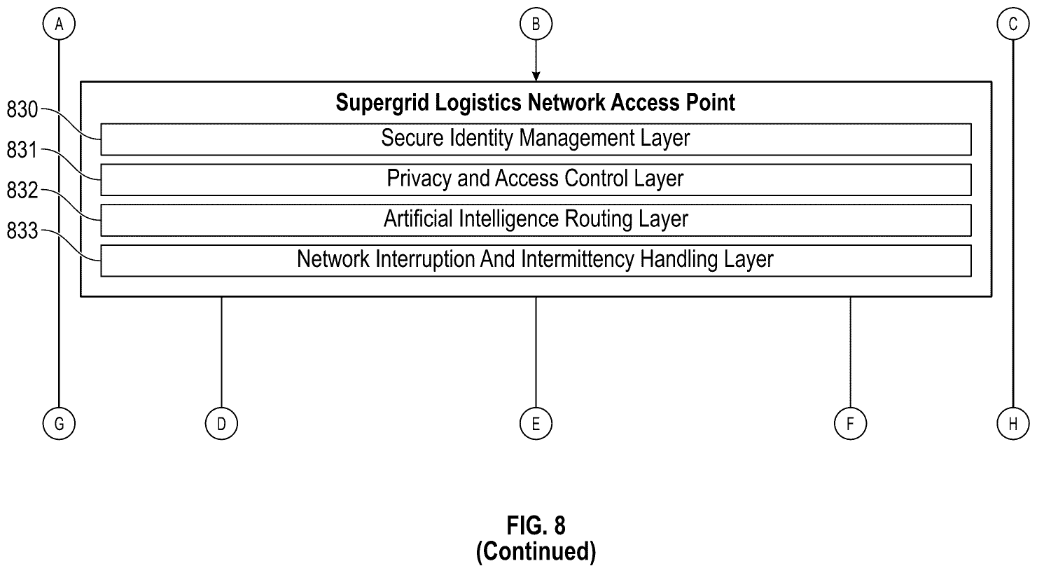

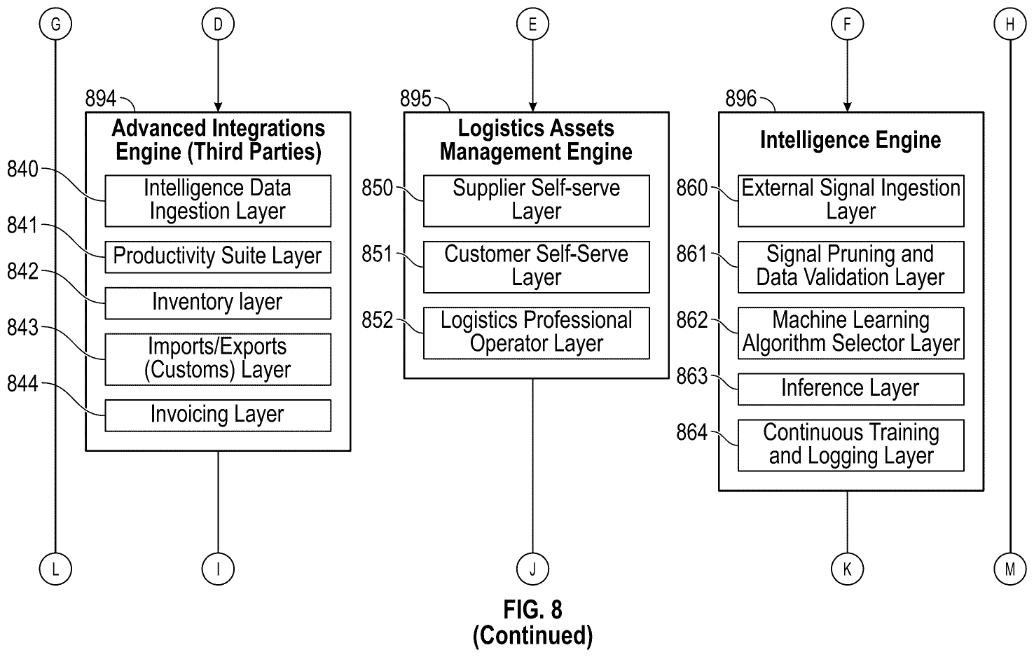

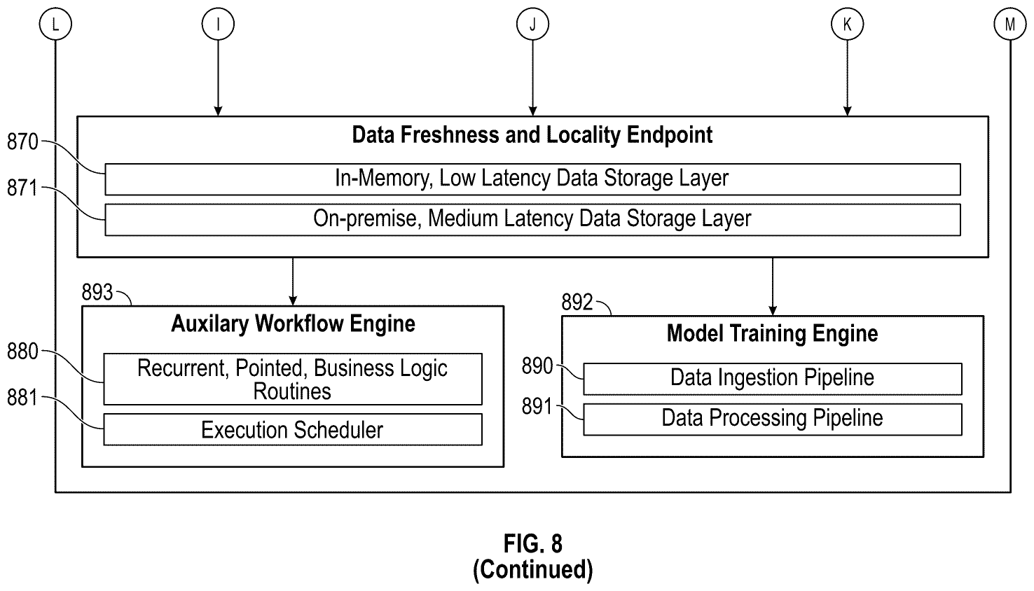

As shown in FIG. 8, which illustrates the interaction within the instant disclosure Logistics (the instant disclosure Logistics) Server Layer 800, which serves as the central motor of the instant disclosure Logistics Network. This layer employs advanced technologies to optimize data transfer and manage logistics operations efficiently. Key terms associated with the instant disclosure Logistics Server Layer include piecemeal TCP, data transfer endpoint 820, fragment optimization 821, authentication and privacy 831, data compression 821, inference (artificial intelligence) 863, and advanced data storage techniques 871.

The interaction within the instant disclosure Logistics Server Layer is structured around three main components that facilitate information sharing and processing.

The first component is the Advanced Integrations Engine, which enables intelligence data ingestion 840, improved data quality, simplified integrations, enhanced scalability, and increased security. This engine leverages sophisticated algorithms and protocols to ensure efficient communication between in-network nodes and external systems 841.

The second component is the Logistics Assets Management Engine, comprising dashboards for suppliers 850, customers 851, and logistics professionals 852. These self-serve dashboards provide real-time insights into supply chain activities, allowing stakeholders to monitor shipments, manage inventory, and track performance metrics.

The third component is the Intelligence Engine, equipped with AI algorithms for logic provision, decision-making, and machine learning 860, 861, 862, 863. This engine processes data from various sources to generate actionable insights and optimize supply chain operations 864.

The processed information from these components is directed to a Data Freshness and Locality Endpoint, which utilizes in-memory 870, low-latency data storage for rapid access and retrieval. Additionally, on-premises medium-latency data storage ensures data integrity and availability 871.

Finally, the information is shared with Strategic Partnerships, including mobile 810, computer 811, and web clients 812, automated notification channels 813, and third-party messaging apps 814. Moreover, a Model Training Engine 892 supports continuous improvement by managing data ingestion 890 and processing pipelines 891, enabling transfer learning and feature optimization within the instant disclosure Logistics Network. This comprehensive architecture ensures efficient data flow and decision-making across the logistics ecosystem.

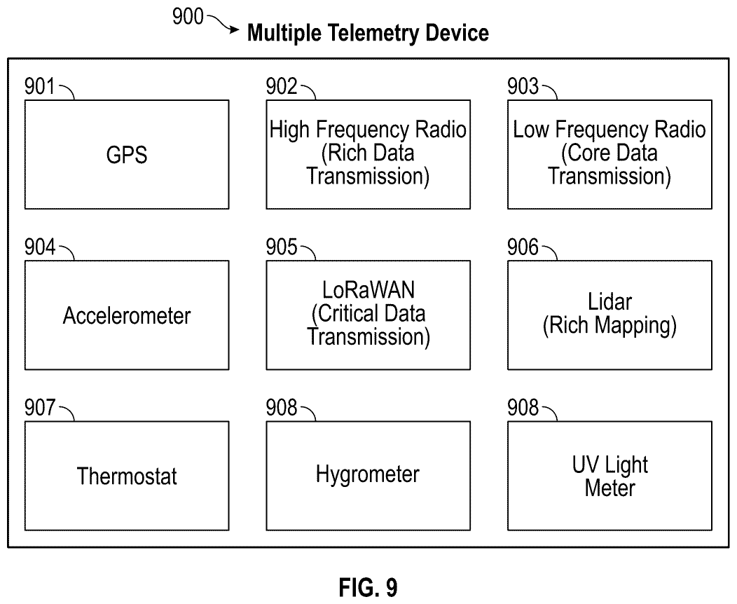

As shown in FIG. 9 it is illustrated that the Multiple Telemetry Device leverages various technologies to enhance the intelligence and security of the SGNL. It uses:
GPS 901 to triangulate a vehicle's location and inform the “Privacy and Access Control Layer” 831 if a vehicle is transmitting data from its expected geolocation. This fends off potential network attacks where the attacker would impersonate a vehicle's ID and gain unauthorized access to the system.
High frequency radio 902 to transmit rich data, such as large information payloads over HTTPS.
Low frequency radio 903 to transmit core data; such each instrument's health and availability, and emergency events.
LoRaWAN 905 to transmit critical data; LoRaWAN is leveraged to transform vehicles into nodes of a dynamic (ever moving) ultra-wide network. LoRaWAN is meant to enable vehicle-to-vehicle data transmission, allowing critical data to flow through the larger SGLN without the need for all nodes to be connected via high/low frequency radio.
Accelerometer 904, Lidar 906, Thermostat 907, Hygrometer 908, UV light meter 909; to enrich the SGLN with field intelligence that will enable higher decision making in the logistics processes involving multiple networks.

A benefit of the instant disclosure is that the instant disclosure Logistics represents a transformative logistics ecosystem engineered to seamlessly integrate and optimize multiple supply chains. This comprehensive network is designed to enhance collaboration, efficiency, and visibility across supply chain operations. The instant disclosure Logistics comprises essential components that are required for core functionality, such as supply and demand ingestion systems 843, a control tower for centralized oversight 880, and an intelligence system for data-driven decision-making 881. Additionally, optional components like notifications, accounting, invoicing 844, and status tracking systems 842 further enhance the ecosystem's capabilities. By leveraging cutting-edge technologies and innovative solutions, the instant disclosure Logistics empowers businesses to streamline logistics processes, accelerate information flow, and unlock new levels of operational excellence in today's interconnected global marketplace.

The instant disclosure has Required Layers and Components:

### 1. Agreement Transaction Layer:

Facilitates transactional processes within the logistics network.
Includes payment systems and smart contracts to ensure secure and efficient agreements between stakeholders.

### 2. Carrier Layer:

Encompasses road cargo companies, air cargo companies, sea cargo companies, ports, customs, and warehouse companies.
Integrates carriers into the logistics network to manage transportation and distribution.

### 3. Shipper Layer:

Includes end customers, retail, trading, and manufacturers.
Represents stakeholders initiating shipments and driving demand within the logistics network.

### 4. The Instant Disclosure Logistics Asset Management:

Manages and optimizes physical assets crucial for logistics operations.
Includes devices such as cellphones, GPS trackers, and IoT devices to monitor asset parameters like geolocation, temperature, humidity, and more.

### 5. The Instant Disclosure Logistics Server Layer:

Core infrastructure layer hosting intelligence engines, advanced integration engines, workflow automation, mobility suites, communications engines, and partner applications.
Enables data processing, analytics, and seamless communication across the logistics network.

### Optional Layer:

### 1. Logistics Third Party Layer:

Enhances ecosystem capabilities by integrating third-party logistics providers.
Enables expanded service offerings, specialized logistics solutions, and broader market reach.

### EXPERIMENTAL AND WORKING EMBODIMENTS

The inventors developed and tested a proof-of-concept system and method focused on marine and land logistics. They joined the previously disjointed logistics networks via internet connected devices (IoT) and informed one another about their relative statuses by real-time processing the data collected on the ground.

This proof of concept may be broken down into four main components:

### 1. Data Producers—System

a. The inventors placed a series of IoT devices in container ships, tracking location, acceleration, humidity, brightness, and shock. These devices constantly transmit their collected information via satellite, directly onto the data processors.

### 2. Data Processors—Method

a. The inventors developed, trained, and deployed artificial intelligence ingestion methods to predict subsequent supply chain networks of events happening in the current network. In this case, they infer the health status of each container onboard a cargo ship, allowing for informed decision making at a designed control center.
b. Additionally, they predict revised departure, arrival, docking, and container unloading times by utilizing the information gathered above and cross-referencing it with information gathered on land by trailer trucks and marine terminals.
c. Ultimately, they leverage their findings to reduce/eliminate idle wait times, infer with precision what time a trucker may pick up a specific container being unloaded from a ship, and how long the customs process would take based on agent availability and other congestion.

### 3. Data Publishers—Method

a. The instant disclosure is designed and developed to create a distributed and reliant data publisher method, taking into account the realities of supply chain operations: intermittent connectivity, low-bandwidth accessibility, and the need for clear and concise visibility into future predicted events. With these constraints in mind, the method is able to handle partial/interrupted data transmissions, local/remote data handling, and multiple delivery channels.

### 4. Data Subscribers—System

a. The inventors developed multi-connectivity devices leveraging GPS, 5G, and Lora WAN technologies. These allow transmission of information between devices as a mesh network, and to/from the rest of the methods described above. Additionally, the interface they developed between the Data Subscribers and handheld computer devices such as cellphones is versatile, so people on the ground are able to visualize and explore all data recorded by the subscriber.

### 1. Data Producers—System

a. The inventors want to expand their current Data Producer manufacturing capability to not be limited to the offerings from third-party vendors. Crucially integrating Lora WAN, Bluetooth, and other low-frequency radio signals in order to amplify long-range connectivity.
b. Additionally, they want to bring manufacturing closer to research so that they may continue innovating in this space.

### 2. Data Processors—Method

a. The inventors designed the novel method from scratch. However, they did have a choice of cloud compute provider; ultimately opting for Google given its Artificial Intelligence hardware versatility and low experimentation costs.

### 3. Data Publishers—Method

a. Likewise, the inventors designed this novel method from scratch. However, unlike the Data Processor method, the Data Publishers tap into Edge Computing. The main choices and limitations here are the Data Producers themselves. Meaning that innovation in point 1 and point 3 are, in part, interconnected. Point 1 focuses on networking and connectivity, while point 3 focuses on resilience and reliability.

### 4. Data Subscribers—System

a. The main objective in this proof of concept was to make a productive working example of the disclosure, so the inventors opted for low-cost data subscriber solutions-laptops and smartphones. These are not ideal, as their battery power keeps them online for relatively short periods of time. They would like to manufacture a device that is optimized for their use-case: low battery usage and a quick and intuitive display.
b. The inventors considered leveraging Amazon Kindle devices; however, limitations in their displays steered them away from pursuing that idea further.
   The distinguishing features of the instant disclosure (the instant disclosure) system and method encompass several key elements that revolutionize supply chain management and logistics operations:
1. Interconnecting Data and Key Players: the instant disclosure integrates data from various stakeholders into a unified network, enhancing collaboration and transparency across the supply chain.
2. Smart Contract with Service Level Agreement (SLA): The system leverages smart contracts linked to SLAs, enabling smart escrows with financial entities. This mechanism automates and secures transactions based on predefined conditions.
3. Lora WAN for IoT Integration: the instant disclosure utilizes Lora WAN technology for IoT devices within the supply chain. This wireless protocol enables long-range, low-power communication, facilitating real-time data collection for geofencing, temperature monitoring, humidity control, vibrations and shock detection, and light sensing.
4. Artificial Intelligence (AI) for Predictive Analytics: AI algorithms are employed for data processing and predictive analytics in supply chain transportation and related services. This technology optimizes route planning, inventory management, and resource allocation based on historical data and real-time insights.
5. Tokenization of Shipment Movements: The system implements tokenization to secure shipment data and transactions. Tokenization replaces sensitive information with unique identifiers (tokens) that maintain data integrity while minimizing security risks associated with data breaches and unauthorized access.
6. IoT Tokenization: IoT tokenization in logistics enables automated payments based on specific criteria defined in service level agreements (SLAs) or business rules. When cargo equipped with IoT devices meets predetermined conditions (e.g., crossing a geofence, reaching a delivery milestone), a unique token representing the logistics event is generated. This token triggers a secure payment transaction, leveraging blockchain or distributed ledger technology for authentication and privacy. IoT tokenization automates payments, enhances security, and ensures traceability in supply chain transactions.
7. Natural Language Processing (NLP) Integration: Tokenization supports NLP applications by breaking down textual content into digestible tokens. This process enables the instant disclosure to comprehend, analyze and allow transactions between parties.
8. Enhanced Information Visibility: the instant disclosure provides comprehensive visibility of critical supply chain information, including global suppliers, available services, routes, pricing details, booking availability, real-time tracking, and predictive analytics.
9. Modular Logistics Services: Additional logistics services may be seamlessly integrated into the supply chain as plugins, leveraging the accessibility and flexibility of the instant disclosure network.
10. Artificial Intelligence of the Internet of Things (AIoT) Data Processing: AIoT plays a pivotal role as a data processor within the instant disclosure, managing the influx of massive data generated across the global supply chain. By integrating AI algorithms with IoT devices, the system efficiently processes and analyzes.

By using real-time data streams from sensors, devices, and connected assets. AIoT capabilities enable predictive analytics, anomaly detection, and optimization of supply chain operations. This integration empowers stakeholders to make data-driven decisions, optimize resource allocation, predict demand patterns, and enhance overall supply chain performance on a global scale. AIoT-driven insights drive efficiency and responsiveness, enabling continuous improvement and adaptability in dynamic logistics environments.

The landscape of supply chain management will undergo a profound transformation driven by advancements in technology. Before the widespread adoption of Graphics Processing Units (GPUs) and Central Processing Units (CPUs) with enhanced computing power, the integration of Artificial Intelligence (AI) into supply chain operations faced significant hurdles. Computational limitations posed by slower CPUs and limited GPU capabilities inhibited the deployment of AI-driven intelligence in IoT devices within supply chains. However, with the emergence of Low Power Wide Area Network (Lora WAN) technology and the Internet of Things (IoT), data collection and interaction monitoring have become scalable and cost-effective, revolutionizing supply chain operations.

Additionally, the use of cryptocurrency and tokenization has extended the reach of Lora WAN by introducing monetary incentives and token-based systems that encourage participation and data sharing among stakeholders. This introduction explores how these technological innovations, coupled with the social adoption of IoT and

AI-enabled systems have empowered businesses and stakeholders to optimize operations, enhance efficiency, and drive sustainable practices within global supply chains.

Key Points of the instant disclosure:
1. Impact of GPU and CPU Advancements: The advancements in Graphics Processing Units (GPUs) and Central Processing Units (CPUs) with enhanced computing power have revolutionized the application of Artificial Intelligence (AI) in supply chain management. Previously, AI algorithms faced significant computational limitations due to slower CPUs and limited GPU capabilities, hindering the integration of AI-driven intelligence into IoT devices and supply chain operations.
2. Lora WAN and IoT Revolution: The emergence of Low Power Wide Area Network (Lora WAN) technology alongside the Internet of Things (IoT) has transformed data collection and interaction monitoring in supply chains. Lora Wan's wireless communication protocol optimizes connectivity for low-power devices over extended ranges, enabling IoT sensors to efficiently gather and transmit data from diverse environments.
3. Scalable Data Collection: With Lora WAN and IoT, organizations may deploy IoT sensors across supply chain networks to monitor assets, environmental conditions, and operational parameters in real-time. This scalable approach to data gathering democratizes access to actionable insights, empowering businesses to optimize operations, reduce costs, and enhance efficiency.
4. Social Adoption and Empowerment: The widespread adoption of IoT and AI-enabled systems in everyday life has cultivated a culture of connectivity and data-driven decision-making. This social integration empowers both suppliers and end-users within supply chains by providing enhanced visibility, transparency, and responsiveness.
5. Utilizing Cryptocurrency for Extended Lora WAN Adoption: The adoption of cryptocurrency and tokenization has expanded the use of Lora WAN in cities worldwide. Blockchain-based systems introduce monetary incentives and token rewards for Lora WAN network implementation, encouraging stakeholders to contribute IoT gateways installation, and device data. Participants earn rewards for sharing data, enhancing network coverage, improving data quality, and fostering collaboration. This approach promotes transparency, trust, and engagement among stakeholders, driving widespread Lora WAN adoption for IoT Technology and for our use in supply chain operations.

In conclusion, the convergence of advanced technologies such as GPUs, Lora WAN, IoT, and AI has unlocked the potential for innovative supply chain solutions like the instant disclosure Logistics Network. Improved computing capabilities, scalable data gathering through Lora WAN, enhanced IoT connectivity, and incentivized data sharing through cryptocurrency have collectively enabled the realization of a comprehensive logistics ecosystem. These advancements empower stakeholders to leverage real-time insights, optimize operations, enhance transparency, and drive continuous improvement in supply chain management, culminating in the development and implementation of transformative logistics networks like the instant disclosure Logistics Network.

It was unexpected and surprising to witness the degree of operational challenges within the logistics industry. Truckers often endure lengthy wait times, spanning hours or even days, to receive their payloads, highlighting inefficiencies in cargo handling and distribution. Similarly, customs agents still rely heavily on manual processes to identify, and document imported goods, underscoring the need for streamlined digital solutions to enhance efficiency and accuracy.

Moreover, the level of connectivity on container ships was less erratic than anticipated, largely due to advancements in commercial satellite internet. This improved connectivity has enabled more seamless communication and data transmission across maritime supply chains, paving the way for enhanced real-time tracking and monitoring capabilities.

In response to these insights, the approach to implementing the instant disclosure (the instant disclosure) has evolved to prioritize solutions that directly address these operational pain points. By leveraging cutting-edge technologies like AI, IoT, and blockchain, the system aims to streamline workflows, automate processes, and enhance connectivity throughout the logistics ecosystem to drive efficiency and competitiveness.

As development continues to advance, the instant disclosure (the instant disclosure) remains committed to integrating new technologies that achieve widespread adoption and success. Looking ahead, technologies like quantum computing and applications within the metaverse hold tremendous potential for revolutionizing logistics and supply chain management.

Quantum computing offers unprecedented computational power, capable of solving complex optimization problems and analyzing massive datasets with remarkable speed. By integrating quantum computing into logistics applications within the instant disclosure, operators may enhance route optimization, supply chain forecasting, and inventory management. Quantum algorithms may efficiently tackle NP-hard problems, deliver real-time insights and drive efficiency across supply chain operations.

In parallel, the metaverse presents innovative opportunities for immersive and interconnected virtual environments. Within logistics, the metaverse may facilitate virtual simulations, training programs, and collaborative workspaces for supply chain professionals. By leveraging the metaverse, the instant disclosure may enhance communication, visualization, and decision-making processes, enabling stakeholders to interact and engage within a virtual logistics ccosystem.

By embracing these transformative technologies and adapting them to logistics applications, the instant disclosure aims to continuously evolve and optimize supply chain operations in an ever-changing landscape. Through ongoing innovation and strategic partnerships, the system is positioned to shape the future of logistics and redefine the possibilities of global trade.

Additionally, the inclusion of AI classification of Harmonized System (HS) codes within the instant disclosure could further enhance supply chain efficiency. HS codes are used to classify goods and products for customs purposes, facilitating international trade and tariff calculations. By integrating HS codes into the instant disclosure, the system may automate product classification, streamline import/export procedures, and improve the accuracy of customs declarations. This integration would not only reduce administrative burdens but also contribute to faster and more efficient cross-border trade operations.

Looking beyond customs integration, future extensions of the instant disclosure could encompass other sectors such as financial transactions, regulatory compliance, sustainability tracking, and risk management. Each layer of the network presents opportunities for expansion and refinement, driven by emerging technologies, industry standards, and evolving market demands. By embracing continuous innovation and collaboration across sectors, the instant disclosure may continue to evolve as a dynamic and transformative platform for global logistics and supply chain management.

### Potential Alternative Designs for the Disclosure Include:

The instant disclosure (the instant disclosure) holds vast potential for transforming supply chain operations and enabling new applications beyond its primary use case. Some potential alternative uses and applications for the instant disclosure are:
Cross-Industry Collaboration: The instant disclosure may facilitate cross-industry collaboration by enabling seamless integration and communication between different sectors such as manufacturing, retail, healthcare, and agriculture. This could lead to innovative partnerships and supply chain optimizations across diverse industries.
Last-Mile Delivery Optimization: the instant disclosure's real-time tracking and predictive analytics capabilities may be leveraged to optimize last-mile delivery operations. By integrating with local delivery services and leveraging IoT devices, the network may provide precise delivery windows and optimize route planning.
Regulatory Compliance and Reporting: The instant disclosure may streamline regulatory compliance processes by automating documentation, reporting, and customs procedures. This could reduce administrative overhead and ensure compliance with international trade regulations.
Supply Chain Finance and Smart Contracts: Implementing smart contracts within the instant disclosure could revolutionize supply chain finance. The network may facilitate automated payment settlements based on predefined conditions, reducing transaction costs and improving cash flow management.
Environmental Impact Monitoring: With IoT sensors integrated into the network, the instant disclosure may monitor environmental impacts throughout the supply chain. This includes tracking carbon emissions, energy consumption, and waste generation, allowing companies to implement sustainable practices and meet environmental targets.
Asset Tracking and Management: Beyond goods and shipments, the instant disclosure may extend its capabilities to track and manage physical assets such as vehicles, containers, and machinery. This may improve asset utilization, reduce downtime, and enhance overall operational efficiency.
Data Monetization and Insights: The instant disclosure may serve as a data monetization platform by offering insights derived from supply chain data to third-party developers, researchers, and analysts. This could unlock and foster innovation in logistics analytics.

These alternative uses demonstrate the versatility and scalability of the instant disclosure beyond its core functions, paving the way for innovative applications and solutions across various industries and sectors.
Supply Chain Finance: the instant disclosure may facilitate supply chain finance by providing transparent and real-time visibility into supply chain transactions. This may enable financial institutions to offer innovative financing solutions based on the reliability and integrity of supply chain data.
Trade and Compliance: the instant disclosure may support trade facilitation and compliance by automating customs processes, ensuring accurate documentation, and improving visibility into the movement of goods across borders. This may streamline international trade and reduce regulatory burdens.
Healthcare Supply Chain: the instant disclosure may be adapted for use in healthcare supply chains to improve the tracking and management of medical products, equipment, and pharmaceuticals. Real-time visibility may enhance inventory management and ensure timely delivery of critical supplies.
Manufacturing Operations: the instant disclosure may optimize manufacturing operations by providing insights into the movement of raw materials, work-in-progress, and finished goods. This may enhance production planning, inventory control, and overall efficiency.
Retail and E-commerce: the instant disclosure may support retail and e-commerce operations by optimizing inventory management, order fulfillment, and last-mile delivery. Real-time tracking and predictive analytics may improve customer satisfaction and reduce operational costs.
Smart Cities: the instant disclosure may contribute to the development of smart cities by optimizing urban logistics, waste management, and public transportation. This may lead to more sustainable and efficient city operations.
Energy and Utilities: the instant disclosure may be leveraged in the energy and utilities sector to optimize supply chain logistics for equipment, spare parts, and maintenance operations. This may improve asset management and reduce downtime.
Government Services: the instant disclosure may support government services by enabling better management of public resources, emergency response logistics, and infrastructure maintenance. Real-time data may enhance decision-making and resource allocation.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail may be made to the described embodiments of the disclosure, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the disclosure should be determined by the appended claims and their legal equivalents.

In addition, while the present disclosure has been described with reference to embodiments, it should be noted and understood that various modifications and variations may be crafted by those skilled in the art without departing from the scope and spirit of the disclosure. Accordingly, the foregoing disclosure should be interpreted as illustrative only and is not to be interpreted in a limiting sense. Further it is intended that any other embodiments of the present disclosure that result from any changes in application or method of use or operation, method of manufacture, shape, size, or materials which are not specified within the detailed written description or illustrations contained herein are considered within the scope of the present disclosure.

Insofar as the description above and the accompanying drawings disclose any additional subject matter that is not within the scope of the claims below, the disclosures are not dedicated to the public and the right to file one or more applications to claim such additional disclosure is reserved.

Although very narrow claims are presented herein, it should be recognized that the scope of this disclosure is much broader than presented by the claim. It is intended that broader claims will be submitted in an application that claims the benefit of priority from this application.

While this disclosure has been described with respect to at least one embodiment, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed:

1. A logistics network system, comprising:
a centralized operator configured to integrate, coordinate, and synchronize multiple supply chain ecosystems;
a plurality of interconnected physical and mobile infrastructures, networks, and smart sensors configured to capture real-time data on asset parameters;
a tokenization module operatively coupled to the interconnected infrastructures and sensors, configured to tokenize the captured real-time data to secure and anonymize sensitive information;
an Artificial Intelligence of Things (AIoT) module configured to analyze the tokenized data to generate predictive analytics and to provide real-time visibility into dynamic pricing, booking availability, payment processing, smart contract execution, and traceability of goods; and
a high-performance computing module comprising Central Processing Units (CPUs) and Graphics Processing Units (GPUs), configured to execute complex algorithms and deep learning models for rapid data processing and optimization of global supply chain operations.

2. The logistics network system of claim 1, wherein the centralized operator is further configured to orchestrate and streamline logistics processes across the multiple supply chain ecosystems.

3. The logistics network system of claim 1, wherein the plurality of interconnected physical and mobile infrastructures, networks, and smart sensors includes devices for capturing real-time data on asset parameters comprising geolocation, temperature, humidity, vibrations, shock, and light exposure.

4. The logistics network system of claim 1, wherein the tokenization module is further configured to generate unique tokens for logistics events that trigger secure payment transactions based on predefined criteria in service level agreements.

5. The logistics network system of claim 1, wherein the AIoT module is further configured to implement machine learning algorithms that continuously adapt and optimize supply chain operations based on historical data and real-time trends.

6. The logistics network system of claim 1, wherein the high-performance computing module is further configured to utilize parallel processing capabilities to simultaneously execute multiple algorithms and deep learning models.

7. The logistics network system of claim 1, further comprising a blockchain component integrated with the smart contract execution, the blockchain component configured to provide records of transactions.

8. A method for operating a logistics network system, comprising:
integrating, coordinating, and synchronizing multiple supply chain ecosystems using a centralized operator;
capturing real-time data on asset parameters using a plurality of interconnected physical and mobile infrastructures, networks, and smart sensors;
tokenizing the captured real-time data via a tokenization module configured to secure and anonymize sensitive information;
analyzing the tokenized data using an Artificial Intelligence of Things (AIoT) module to generate predictive analytics and provide real-time visibility data including dynamic pricing, booking availability, payment processing, smart contract execution, and traceability of goods; and
executing complex algorithms and deep learning models using a high-performance computing module comprising Central Processing Units (CPUs) and Graphics Processing Units (GPUs) for rapid data processing and optimization of global supply chain operations.

9. The method of claim 8, further comprising orchestrating and streamlining logistics processes across the multiple supply chain ecosystems via the centralized operator.

10. The method of claim 8, wherein capturing real-time data on asset parameters comprises capturing data on geolocation, temperature, humidity, vibrations, shock, and light exposure.

11. The method of claim 8, further comprising triggering, based on the analyzed tokenized data, secure payment transactions based on predefined criteria in service level agreements.

12. The method of claim 8, wherein analyzing the tokenized data comprises continuously adapting and optimizing supply chain operations based on historical data and real-time trends.

13. The method of claim 12, wherein the historical data and real-time trends is based on the real-time visibility data.

14. The method of claim 8, further comprising a blockchain component integrated with the smart contract execution, the blockchain component configured to provide records of transactions.

15. A non-transitory computer-readable medium storing instructions that, when executed by one or more processors, cause the one or more processors to perform operations comprising:
integrating, coordinating, and synchronizing multiple supply chain ecosystems using a centralized operator;
capturing real-time data on asset parameters using a plurality of interconnected physical and mobile infrastructures, networks, and smart sensors;
tokenizing the captured real-time data via a tokenization module configured to secure and anonymize sensitive information;
analyzing the tokenized data using an Artificial Intelligence of Things (AIoT) module to generate predictive analytics and provide real-time visibility data including dynamic pricing, booking availability, payment processing, smart contract execution, and traceability of goods; and
executing complex algorithms and deep learning models using a high-performance computing module comprising Central Processing Units (CPUs) and Graphics Processing Units (GPUs) for rapid data processing and optimization of global supply chain operations.

16. The non-transitory computer-readable medium of claim 15, wherein the operations further comprise orchestrating and streamlining logistics processes across the multiple supply chain ecosystems via the centralized operator.

17. The non-transitory computer-readable medium of claim 15, wherein capturing real-time data on asset parameters comprises capturing data on geolocation, temperature, humidity, vibrations, shock, and light exposure.

18. The non-transitory computer-readable medium of claim 15, wherein the operations further comprise generating unique tokens for logistics events that trigger secure payment transactions based on predefined criteria in service level agreements.

19. The non-transitory computer-readable medium of claim 15, wherein analyzing the tokenized data comprises continuously adapting and optimizing supply chain operations based on historical data and real-time trends.

20. The non-transitory computer-readable medium of claim 19, wherein the historical data and real-time trends is based on the real-time visibility data.
